(19) United States
(12) Patent Application Publication
(10) Pub. No.: US 2025/0283974 A1
(43) Pub. Date: Sep. 11, 2025

(54) HYBRID CONTINUOUS-WAVE RADAR TECHNIQUES FOR RADIO FREQUENCY SENSING

(71) Applicant: QUALCOMM Incorporated, San Diego, CA (US)

(72) Inventors: Weimin DUAN, San Diego, CA (US); Kangqi LIU, San Diego, CA (US)

(21) Appl. No.: 18/600,463

(22) Filed: Mar. 8, 2024

(51) Int. Cl. G01S 7/35; G01S 7/00; G01S 7/02; G01S 13/58

(52) U.S. Cl. CPC G01S 7/35; G01S 7/006; G01S 7/023; G01S 13/584

(57) ABSTRACT

Disclosed are techniques for wireless communication. In an aspect, a sensing node may receive an indication to transmit a sensing reference signal (RS) having one or more scrambled continuous-wave waveform components. The sensing node may transmit a hybrid continuous-wave radar signal. In some case, the hybrid continuous-wave radar signal may comprise at least one unscrambled continuous-wave waveform component and at least one scrambled continuous-wave waveform component.

### BACKGROUND OF THE DISCLOSURE

### 1. Field of the Disclosure

Aspects of the disclosure relate generally to wireless technologies.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a sensing node includes receiving an indication to transmit a sensing reference signal (RS) having one or more scrambled continuous-wave waveform components; and transmitting a hybrid continuous-wave radar signal, wherein the hybrid continuous-wave radar signal comprises at least one unscrambled continuous-wave waveform component and at least one scrambled continuous-wave waveform component.

In some aspects, the at least one unscrambled continuous-wave waveform component of the hybrid continuous-wave radar signal is transmitted during a first time duration, and the at least one scrambled continuous-wave waveform component of the hybrid continuous-wave radar signal is transmitted during a second time duration different from the first time duration.

In some aspects, the at least one unscrambled continuous-wave waveform component of the hybrid continuous-wave radar signal is transmitted during a first symbol in a time domain, and the at least one scrambled continuous-wave waveform component of the hybrid continuous-wave radar signal is transmitted during a second symbol in the time domain different from the first symbol.

In some aspects, each of the first symbol and the second symbol is compatible with a cyclic prefix (CP) orthogonal frequency division multiplexing (CP-OFDM) symbol.

In some aspects, the at least one unscrambled continuous-wave waveform component of the hybrid continuous-wave radar signal is transmitted during a first portion of a symbol in a time domain, and the at least one scrambled continuous-wave waveform component of the hybrid continuous-wave radar signal is transmitted during a second portion of the symbol in the time domain different from the first portion.

In some aspects, the hybrid continuous-wave radar signal comprises a chirp sequence, the first portion of the symbol is a first chirp of the chirp sequence, and the second portion of the symbol is a second chirp of the of the chirp sequence immediately following the first chirp.

In some aspects, the method includes receiving signaling that indicates a predefined format of the hybrid continuous-wave radar signal to use for transmission, or selecting, absent signaling, the predefined format of the hybrid continuous-wave radar signal to use for the transmission.

In some aspects, the method includes receiving signaling corresponding to an RS configuration that indicates a format of the hybrid continuous-wave radar signal to use for transmission on at least one RS resource.

In some aspects, the at least one scrambled continuous-wave waveform component comprises a number of scrambled continuous-wave waveform components based on an estimation of interference associated with the at least one RS resource.

In some aspects, the format of the hybrid continuous-wave radar signal indicates at least one tuning gap between the at least one unscrambled continuous-wave waveform component and the at least one scrambled continuous-wave waveform component.

In some aspects, the at least one scrambled continuous-wave waveform component comprises a phase-coded (PC) frequency-modulated continuous wave (PC-FMCW) waveform component or a frequency domain-scrambled digital FMCW waveform component, and the at least one unscrambled continuous-wave waveform component comprises an FMCW waveform component.

In an aspect, a method of wireless communication performed by a sensing node includes transmitting an indication of support to receive a sensing reference signal (RS) having one or more scrambled continuous-wave waveform components; and receiving a hybrid continuous-wave radar signal, wherein the hybrid continuous-wave radar signal comprises at least one unscrambled continuous-wave waveform component and at least one scrambled continuous-wave waveform component.

In some aspects, the method includes transmitting an indication for one or more tuning gaps between unscrambled continuous-wave waveform components and scrambled continuous-wave waveform components.

In some aspects, the method includes transmitting an indication of a minimum tuning gap between an unscrambled continuous-wave waveform component and a scrambled continuous-wave waveform component.

In some aspects, the method includes receiving signaling corresponding to an RS configuration that indicates one or more of: a format of the hybrid continuous-wave radar signal for transmission on at least one RS resource, one or more parameters associated with the at least one unscrambled continuous-wave waveform component and at least one scrambled continuous-wave waveform component, one or more parameters associated with the at least one unscrambled continuous-wave waveform component and at least one scrambled continuous-wave waveform component, information corresponding to scrambling associated with the at least one scrambled continuous-wave waveform component, or any combination thereof.

In some aspects, the method includes detecting a target based on a first range-Doppler profile using the at least one scrambled continuous-wave waveform component; and estimating one or more parameters associated with the target based on a second range-Doppler profile using the at least one unscrambled continuous-wave waveform component.

In an aspect, a sensing node includes one or more memories; one or more transceivers; and one or more processors communicatively coupled to the one or more memories and the one or more transceivers, the one or more processors, either alone or in combination, configured to: receive, via the one or more transceivers, an indication to transmit a sensing reference signal (RS) having one or more scrambled continuous-wave waveform components; and transmit, via the one or more transceivers, a hybrid continuous-wave radar signal, wherein the hybrid continuous-wave radar signal comprises at least one unscrambled continuous-wave waveform component and at least one scrambled continuous-wave waveform component.

In an aspect, a sensing node includes one or more memories; one or more transceivers; and one or more processors communicatively coupled to the one or more memories and the one or more transceivers, the one or more processors, either alone or in combination, configured to: transmit, via the one or more transceivers, an indication of support to receive a sensing reference signal (RS) having one or more scrambled continuous-wave waveform components; and receive, via the one or more transceivers, a hybrid continuous-wave radar signal, wherein the hybrid continuous-wave radar signal comprises at least one unscrambled continuous-wave waveform component and at least one scrambled continuous-wave waveform component.

In an aspect, a sensing node includes means for receiving an indication to transmit a sensing reference signal (RS) having one or more scrambled continuous-wave waveform components; and means for transmitting a hybrid continuous-wave radar signal, wherein the hybrid continuous-wave radar signal comprises at least one unscrambled continuous-wave waveform component and at least one scrambled continuous-wave waveform component.

In an aspect, a sensing node includes means for transmitting an indication of support to receive a sensing reference signal (RS) having one or more scrambled continuous-wave waveform components; and means for receiving a hybrid continuous-wave radar signal, wherein the hybrid continuous-wave radar signal comprises at least one unscrambled continuous-wave waveform component and at least one scrambled continuous-wave waveform component.

In an aspect, a non-transitory computer-readable medium stores computer-executable instructions that, when executed by a sensing node, cause the sensing node to: receive an indication to transmit a sensing reference signal (RS) having one or more scrambled continuous-wave waveform components; and transmit a hybrid continuous-wave radar signal, wherein the hybrid continuous-wave radar signal comprises at least one unscrambled continuous-wave waveform component and at least one scrambled continuous-wave waveform component.

In an aspect, a non-transitory computer-readable medium stores computer-executable instructions that, when executed by a sensing node, cause the sensing node to: transmit an indication of support to receive a sensing reference signal (RS) having one or more scrambled continuous-wave waveform components; and receive a hybrid continuous-wave radar signal, wherein the hybrid continuous-wave radar signal comprises at least one unscrambled continuous-wave waveform component and at least one scrambled continuous-wave waveform component.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIGS. 4A and 4B illustrate different types of wireless sensing, according to aspects of the disclosure.

FIG. 5 illustrates an example call flow for a New Radio (NR)-based sensing procedure in which the network configures the sensing parameters, according to aspects of the disclosure.

FIG. 6 illustrates an example of a sensing network with multiple sensing nodes, according to aspects of the disclosure.

FIG. 7 illustrates an example of an interference simulation graph for received sensing signals, according to aspects of the disclosure.

FIG. 8 illustrates an example of a circuit block diagram of one or more devices that perform RF sensing, according to aspects of the disclosure.

FIGS. 9A to 9C illustrate examples of time and frequency graphs for signals corresponding to the circuit block diagram of FIG. 8, according to aspects of the disclosure.

FIG. 10 illustrates examples of range estimation graphs for unscrambled and scrambled sensing signals, according to aspects of the disclosure.

FIGS. 11A to 11C illustrate examples of range mapping diagrams and detection graphs for unscrambled and scrambled sensing signals, according to aspects of the disclosure.

FIG. 12 illustrates an example of a sensing network with multiple sensing nodes according to aspects of the disclosure.

FIG. 13 illustrates examples of hybrid continuous-wave waveforms, according to aspects of the disclosure.

FIG. 14 illustrates examples of range mapping diagrams for unscrambled and scrambled sensing signals, according to aspects of the disclosure.

FIGS. 15 and 16 illustrate example processes of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to hybrid continuous-wave radar techniques for radio frequency (RF) sensing. Some aspects more specifically relate to hybrid frequency modulation continuous wave (FMCW) radar techniques for secure and interference robust RF sensing. That is, for example, a sensing reference signal using hybrid FMCW radar techniques may be configured to include at least one unscrambled FMCW waveform component and at least one scrambled FMCW waveform component. In some examples, the sensing RS may be transmitted on one or more symbols. For example, the sensing RS may be transmitted in multiple symbols such that one or more symbols include one or more unscrambled FMCW waveform components and one or more other symbols include one or more scrambled FMCW waveform components. In some examples, the sensing reference signal may be transmitted on a symbol such that one or more unscrambled FMCW waveform components are included in a first portion of the symbol and one or more scrambled FMCW waveform components are included in a second portion of the same symbol.

Particular aspects of the subject matter described in this disclosure can be implemented to realize one or more of the following potential advantages. In some examples, by including unscrambled and scrambled FMCW waveform components in one or more symbols of a sensing reference signal, the hybrid-FMCW radar transmission may mitigate cross-node interference while achieving sufficient dynamic range for target detection. In some examples, by including unscrambled and scrambled FMCW waveform components in one or more symbols of a sensing reference signal, the hybrid-FMCW radar transmission may enable secure sensing operation. That is, for example, a signal attack from an aggressor sensing node may be filtered out through the scrambled FMCW waveform component while the performance of the sensing operation can still be maintained through the unscrambled FMCW waveform component.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference RF signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

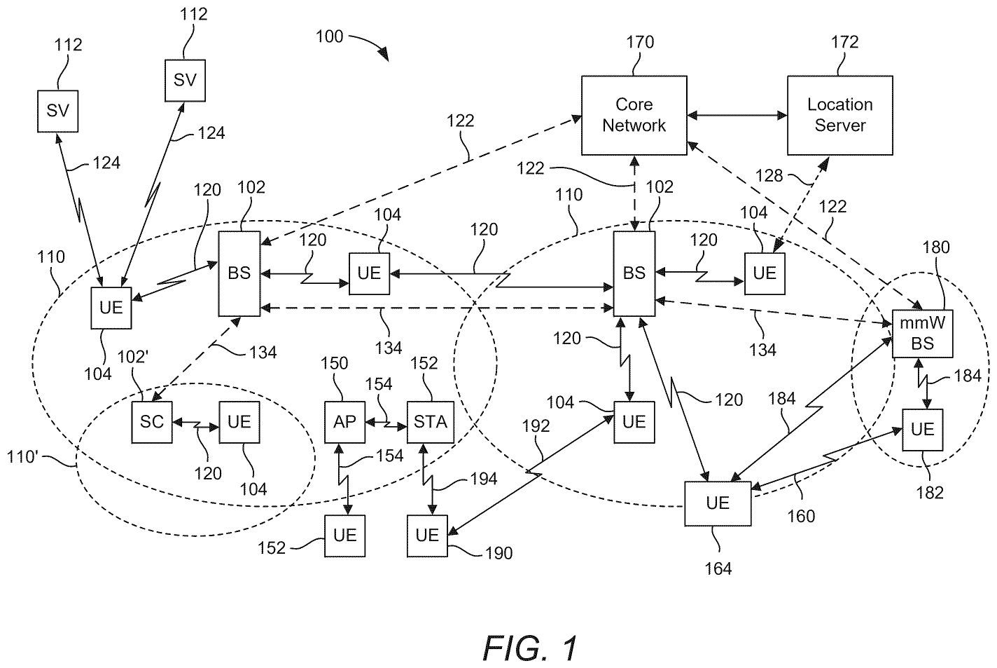

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHZ) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHZ), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (cV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

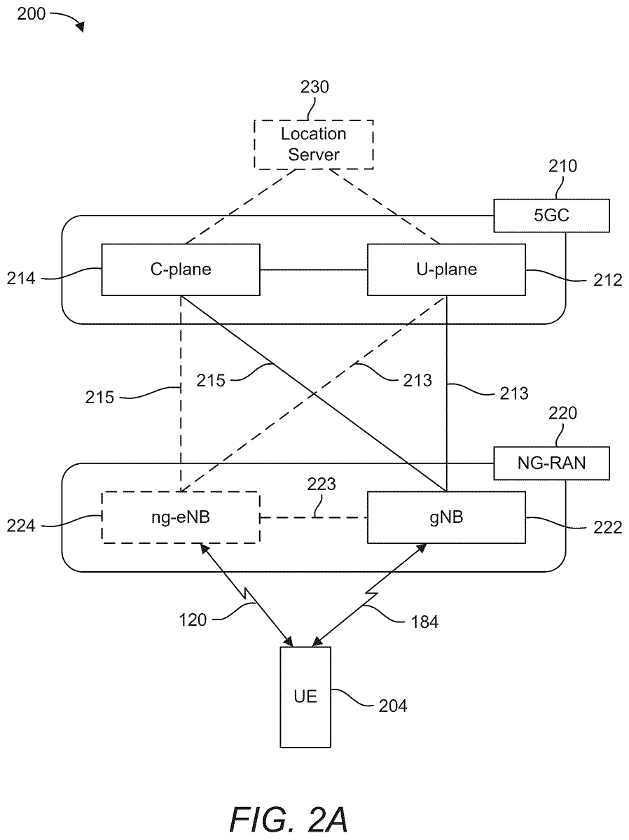

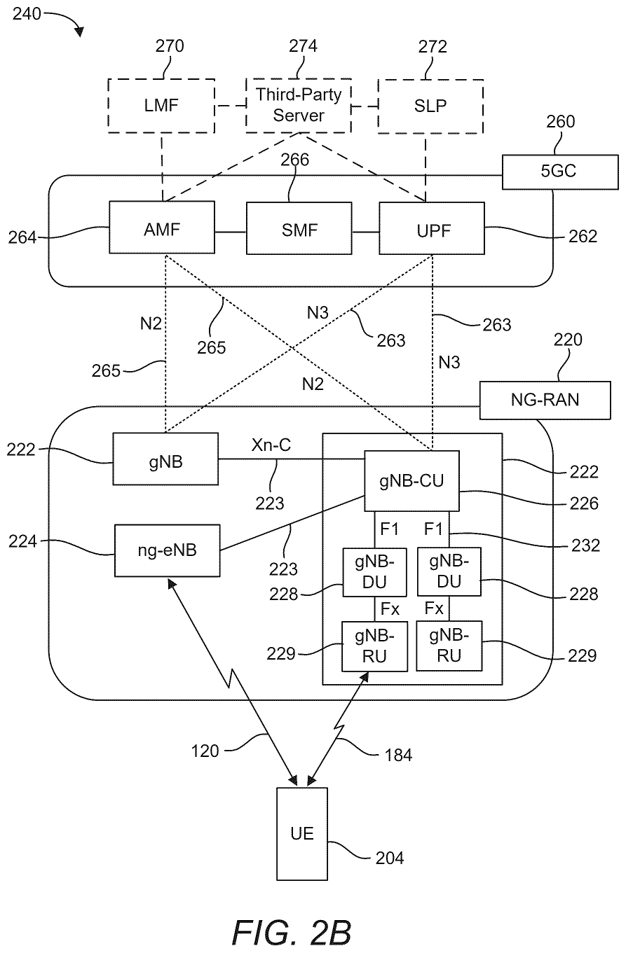

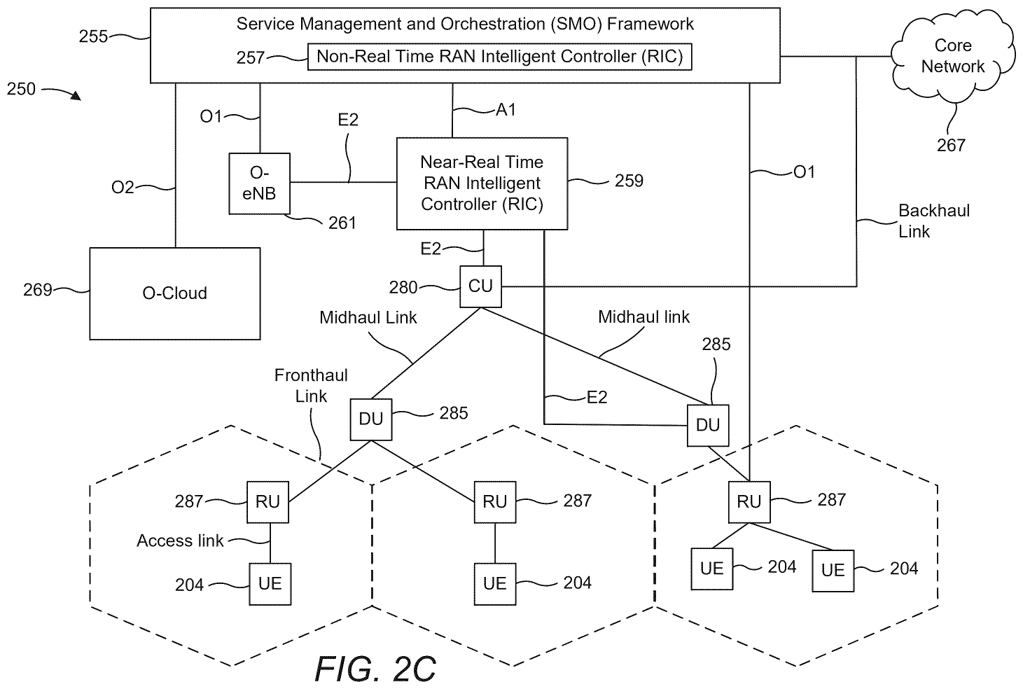

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUS) 287 (e.g., gNB-RUs 229) via respective fronthaul links. The RUs 287 may communicate with respective UEs 204 via one or more RF access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

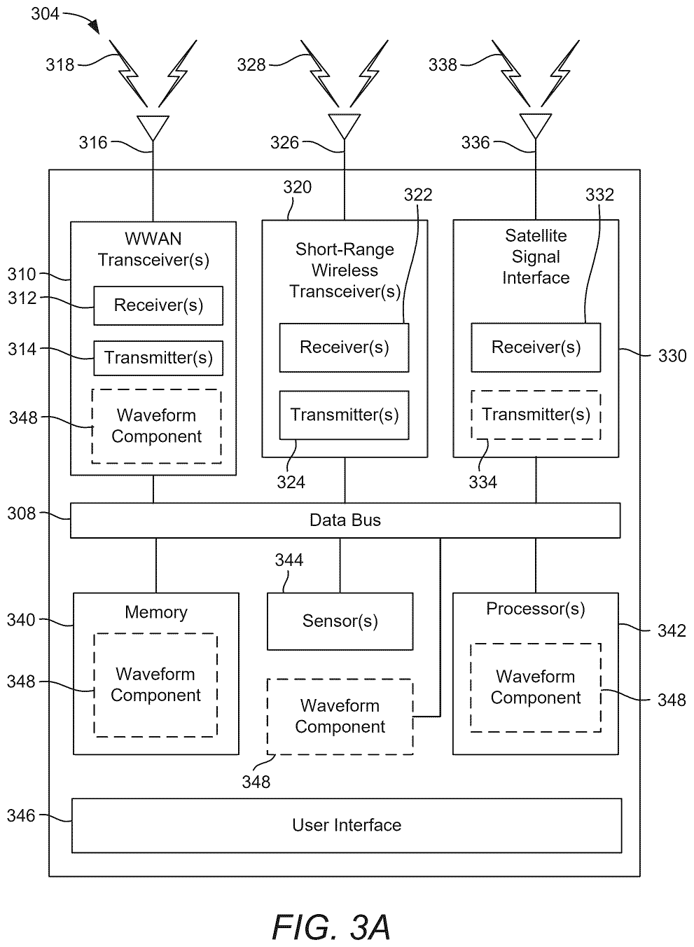

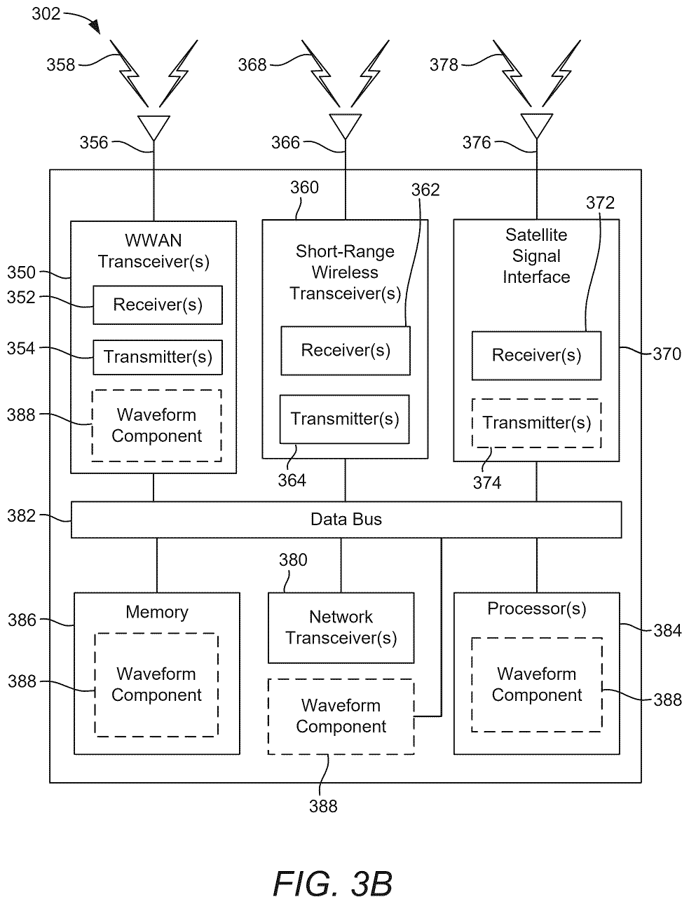

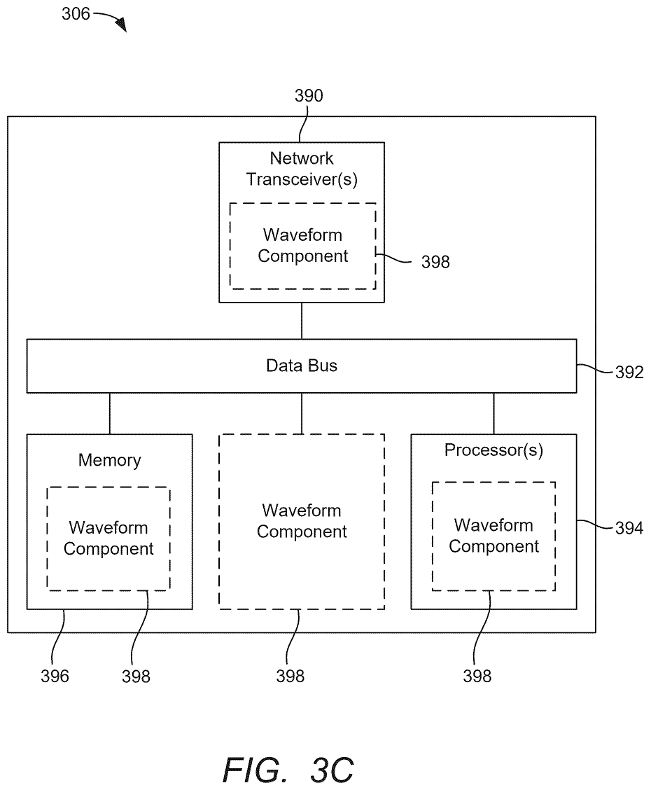

FIGS. 3A, 3B, and 3C illustrate several example components (represented by corresponding blocks) that may be incorporated into a UE 304 (which may correspond to any of the UEs described herein), a base station 302 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 304 and the base station 302 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 304 and the base station 302 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 304 and the base station 302 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 302 may be a terrestrial base station that may communicate with space vehicles (e.g., space vehicles 112) via the satellite signal interface 370. In other cases, the base station 302 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 304 and the base station 302, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 302 and the network entity 306 each include one or more network transceivers 380 and 390, respectively, providing means for communicating (e.g., means for transmitting, means for receiving, etc.) with other network entities (e.g., other base stations 302, other network entities 306). For example, the base station 302 may employ the one or more network transceivers 380 to communicate with other base stations 302 or network entities 306 over one or more wired or wireless backhaul links. As another example, the network entity 306 may employ the one or more network transceivers 390 to communicate with one or more base station 302 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 304, base station 302) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 304, base station 302) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 304) and a base station (e.g., base station 302) will generally relate to signaling via a wireless transceiver.

The UE 304, the base station 302, and the network entity 306 also include other components that may be used in conjunction with the operations as disclosed herein. The UE 304, the base station 302, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 304, the base station 302, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 304, the base station 302, and the network entity 306 may include waveform component 348, 388, and 398, respectively. The waveform component 348, 388, and 398 may be hardware circuits that are part of or coupled to the processors 342, 384, and 394, respectively, that, when executed, cause the UE 304, the base station 302, and the network entity 306 to perform the functionality described herein. In other aspects, the waveform component 348, 388, and 398 may be external to the processors 342, 384, and 394 (e.g., part of a modem processing system, integrated with another processing system, etc.). Alternatively, the waveform component 348, 388, and 398 may be memory modules stored in the memories 340, 386, and 396, respectively, that, when executed by the processors 342, 384, and 394 (or a modem processing system, another processing system, etc.), cause the UE 304, the base station 302, and the network entity 306 to perform the functionality described herein. FIG. 3A illustrates possible locations of the waveform component 348, which may be, for example, part of the one or more WWAN transceivers 310, the memory 340, the one or more processors 342, or any combination thereof, or may be a standalone component. FIG. 3B illustrates possible locations of the waveform component 388, which may be, for example, part of the one or more WWAN transceivers 350, the memory 386, the one or more processors 384, or any combination thereof, or may be a standalone component. FIG. 3C illustrates possible locations of the waveform component 398, which may be, for example, part of the one or more network transceivers 390, the memory 396, the one or more processors 394, or any combination thereof, or may be a standalone component.

The UE 304 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 304 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 302 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 304. Each spatial stream may then be provided to one or more different antennas 356. The transmitter 354 may modulate an RF carrier with a respective spatial stream for transmission.

At the UE 304, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 304. If multiple spatial streams are destined for the UE 304, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 302. These soft decisions may be based on channel estimates computed by a channel estimator. The soft decisions are then decoded and de-interleaved to recover the data and control signals that were originally transmitted by the base station 302 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 302, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 302 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 302 in a manner similar to that described in connection with the receiver function at the UE 304. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 304. IP packets from the one or more processors 384 may be provided to the core network. The one or more processors 384 are also responsible for error detection.

For convenience, the UE 304, the base station 302, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 304 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 302 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 304, the base station 302, and the network entity 306 may be communicatively coupled to each other over data buses 308, 382, and 392, respectively. In an aspect, the data buses 308, 382, and 392 may form, or be part of, a communication interface of the UE 304, the base station 302, and the network entity 306, respectively. For example, where different logical entities are embodied in the same device (e.g., gNB and location server functionality incorporated into the same base station 302), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 304 (e.g., by execution of appropriate code and/or by appropriate configuration of processor components). Similarly, some or all of the functionality represented by blocks 350 to 388 may be implemented by processor and memory component(s) of the base station 302 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 304, base station 302, network entity 306, etc., such as the processors 342, 384, 394, the transceivers 310, 320, 350, and 360, the memories 340, 386, and 396, the waveform component 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 304 via the base station 302 or independently from the base station 302 (e.g., over a non-cellular communication link, such as Wi-Fi).

Wireless communication signals (e.g., RF signals configured to carry OFDM symbols in accordance with a wireless communications standard, such as LTE, NR, etc.) transmitted between a UE and a base station can be used for environment sensing (also referred to as “RF sensing” or “radar”). Using wireless communication signals for environment sensing can be regarded as consumer-level radar with advanced detection capabilities that enable, among other things, touchless/device-free interaction with a device/system. The wireless communication signals may be cellular communication signals, such as LTE or NR signals, WLAN signals, such as Wi-Fi signals, etc. As a particular example, the wireless communication signals may be an OFDM waveform as utilized in LTE and NR. High-frequency communication signals, such as millimeter wave (mmW) RF signals, are especially beneficial to use as sensing signals because the higher frequency provides, at least, more accurate range (distance) detection.

Possible use cases of RF sensing include health monitoring use cases, such as heartbeat detection, respiration rate monitoring, and the like, gesture recognition use cases, such as human activity recognition, keystroke detection, sign language recognition, and the like, contextual information acquisition use cases, such as location detection/tracking, direction finding, range estimation, and the like, and automotive sensing use cases, such as smart cruise control, collision avoidance, and the like.

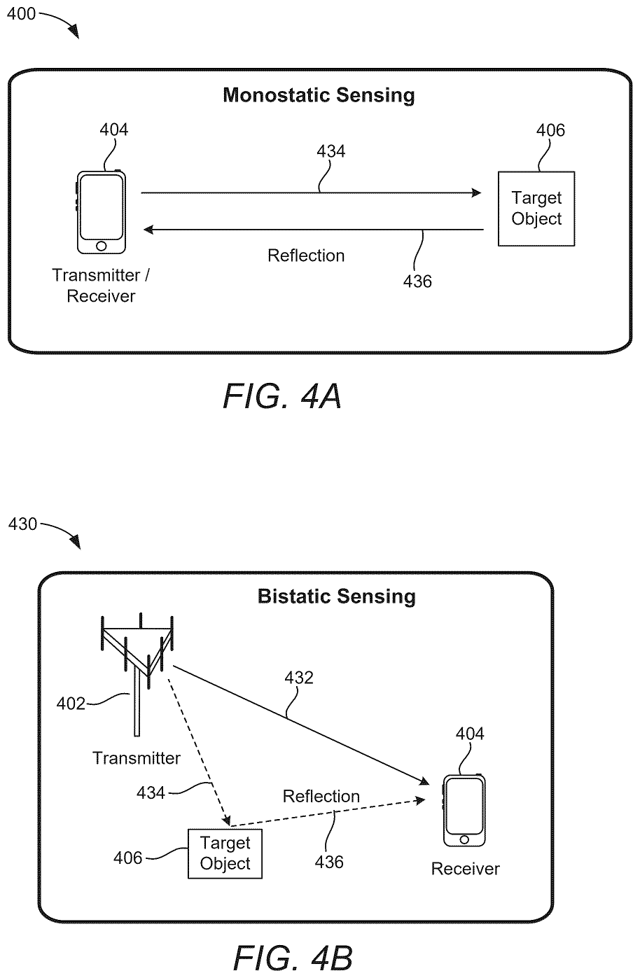

There are different types of sensing, including monostatic sensing (also referred to as “active sensing”) and bistatic sensing (also referred to as “passive sensing”). FIGS. 4A and 4B illustrate these different types of sensing. Specifically, FIG. 4A is a diagram 400 illustrating a monostatic sensing scenario and FIG. 4B is a diagram 430 illustrating a bistatic sensing scenario. In FIG. 4A, the transmitter (Tx) and receiver (Rx) are co-located in the same sensing device 404 (e.g., a UE). The sensing device 404 transmits one or more RF sensing signals 434 (e.g., uplink or sidelink positioning reference signals (PRS) where the sensing device 404 is a UE), and some of the RF sensing signals 434 reflect off a target object 406. The sensing device 404 can measure various properties (e.g., times of arrival (ToAs), angles of arrival (AoAs), phase shift, etc.) of the reflections 436 of the RF sensing signals 434 to determine characteristics of the target object 406 (e.g., size, shape, speed, motion state, etc.).

In FIG. 4B, the transmitter (Tx) and receiver (Rx) are not co-located, that is, they are separate devices (e.g., a UE and a base station). Note that while FIG. 4B illustrates using a downlink RF signal as the RF sensing signal 432, uplink RF signals or sidelink RF signals can also be used as RF sensing signals 432. In a downlink scenario, as shown, the transmitter is a base station and the receiver is a UE, whereas in an uplink scenario, the transmitter is a UE and the receiver is a base station.

Referring to FIG. 4B in greater detail, the transmitter device 402 transmits RF sensing signals 432 and 434 (e.g., positioning reference signals (PRS)) to the sensing device 404, but some of the RF sensing signals 434 reflect off a target object 406. The sensing device 404 (also referred to as the “sensing device”) can measure the times of arrival (ToAs) of the RF sensing signals 432 received directly from the transmitter device and the ToAs of the reflections 436 of the RF sensing signals 434 reflected from the target object 406.

More specifically, as described above, a transmitter device (e.g., a base station) may transmit a single RF signal or multiple RF signals to a sensing device (e.g., a UE). However, the receiver may receive multiple RF signals corresponding to each transmitted RF signal due to the propagation characteristics of RF signals through multipath channels. Each path may be associated with a cluster of one or more channel taps. Generally, the time at which the receiver detects the first cluster of channel taps is considered the ToA of the RF signal on the line-of-site (LOS) path (i.e., the shortest path between the transmitter and the receiver). Later clusters of channel taps are considered to have reflected off objects between the transmitter and the receiver and therefore to have followed non-LOS (NLOS) paths between the transmitter and the receiver.

Thus, referring back to FIG. 4B, the RF sensing signals 432 followed the LOS path between the transmitter device 402 and the sensing device 404, and the RF sensing signals 434 followed an NLOS path between the transmitter device 402 and the sensing device 404 due to reflecting off the target object 406. The transmitter device 402 may have transmitted multiple RF sensing signals 432, 434, some of which followed the LOS path and others of which followed the NLOS path. Alternatively, the transmitter device 402 may have transmitted a single RF sensing signal in a broad enough beam that a portion of the RF sensing signal followed the LOS path (RF sensing signal 432) and a portion of the RF sensing signal followed the NLOS path (RF sensing signal 434).

Based on the ToA of the LOS path, the ToA of the NLOS path, and the speed of light, the sensing device 404 can determine the distance to the target object(s). For example, the sensing device 404 can calculate the distance to the target object as the difference between the ToA of the LOS path and the ToA of the NLOS path multiplied by the speed of light. In addition, if the sensing device 404 is capable of receive beamforming, the sensing device 404 may be able to determine the general direction to a target object as the direction (angle) of the receive beam on which the RF sensing signal following the NLOS path was received. That is, the sensing device 404 may determine the direction to the target object as the angle of arrival (AoA) of the RF sensing signal, which is the angle of the receive beam used to receive the RF sensing signal. The sensing device 404 may then optionally report this information to the transmitter device 402, its serving base station, an application server associated with the core network, an external client, a third-party application, or some other sensing entity. Alternatively, the sensing device 404 may report the ToA measurements to the transmitter device 402, or other sensing entity (e.g., if the sensing device 404 does not have the processing capability to perform the calculations itself), and the transmitter device 402 may determine the distance and, optionally, the direction to the target object 406.

Note that if the RF sensing signals are uplink RF signals transmitted by a UE to a base station, the base station would perform object detection based on the uplink RF signals just like the UE does based on the downlink RF signals.

Like conventional radar, wireless communication-based sensing signals can be used to estimate the range (distance), velocity (Doppler), and angle (AoA) of a target object. However, the performance (e.g., resolution and maximum values of range, velocity, and angle) may depend on the design of the reference signal.

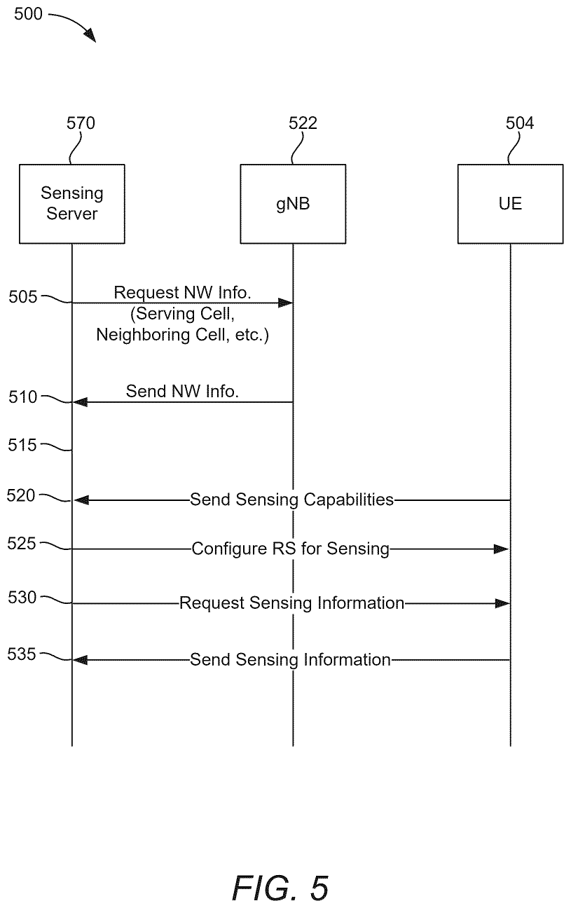

FIG. 5 illustrates an example call flow 500 for an NR-based sensing procedure (e.g., a bistatic sensing procedure) in which the network configures the sensing parameters, according to aspects of the disclosure. Although FIG. 5 illustrates a network-coordinated sensing procedure, the sensing procedure could be coordinated over sidelink channels.

At stage 505, a sensing server 570 (e.g., inside or outside the core network) sends a request for network (NW) information to a gNB 522 (e.g., the serving gNB of a UE 504). The request may be for a list of the UE's 504 serving cell and any neighboring cells. At stage 510, the gNB 522 sends the requested information to the sensing server 570. At stage 515, the sensing server 570 sends a request for sensing capabilities to the UE 504. At stage 520, the UE 504 provides its sensing capabilities to the sensing server 570.

At stage 525, the sensing server 570 sends a configuration to the UE 504 indicating one or more reference signal (RS) resources that will be transmitted for sensing. The reference signal resources may be transmitted by the serving and/or neighboring cells identified at stage 510. In some cases, the NR-based sensing procedure illustrated in FIG. 5 may be a sensing-only procedure or a joint communication and sensing (JCS) procedure. In the case of a sensing-only procedure, the reference signal resources may be reference signal resources specifically configured for sensing purposes. In the case of a JCS procedure, the reference signal resources may be reference signal resources for communication that can also be used for sensing purposes. Alternatively, the reference signal resources for sensing may be multiplexed (e.g., time-division multiplexed) with reference signal resources for communication. For example, the reference signal resources for communication may be an OFDM waveform, while the reference signal resources for sensing may be a FMCW waveform.

At stage 530, the sensing server 570 sends a request for sensing information to the UE 504. The UE 504 then measures the transmitted reference signals and, at stage 535, sends the measurements, or any sensing results determined from the measurements, to the sensing server 570.

In an aspect, the communication between the UE 504 and the sensing server 570 may be via the LTE positioning protocol (LPP). The communication between the sensing server 570 and the gNB may be via NR positioning protocol type A (NRPPa).

Aspects of the disclosure relate to hybrid continuous-wave radar techniques for secure and interference robust RF sensing. In some examples, the hybrid continuous-wave radar techniques overcome various challenges associated with FMCW radar transmissions necessary for robust and scalable RF sensing operations in networks, such as 3GPP NR 5G Advanced networks. In some examples, the hybrid continuous-wave radar techniques may also enable secure sensing operations. That is, for example, an attacking transmission may be filtered out through use of scrambled FMCW waveform components in the reference signal transmissions, while certain performance aspects are maintained through use of unscrambled FMCW waveform components in the reference signal transmissions.

As described herein, these hybrid continuous-wave radar techniques and corresponding waveform transmissions are used in examples of RF sensing operations. In some cases, however, these hybrid continuous-wave radar techniques may also be used for positioning operations. That is, for example, 3GPP 6G networks and other advanced networks may use these hybrid continuous-wave radar techniques for secure and interference robust positioning operations (e.g., PRS waveform transmissions having unscrambled and scrambled FMCW waveform components).

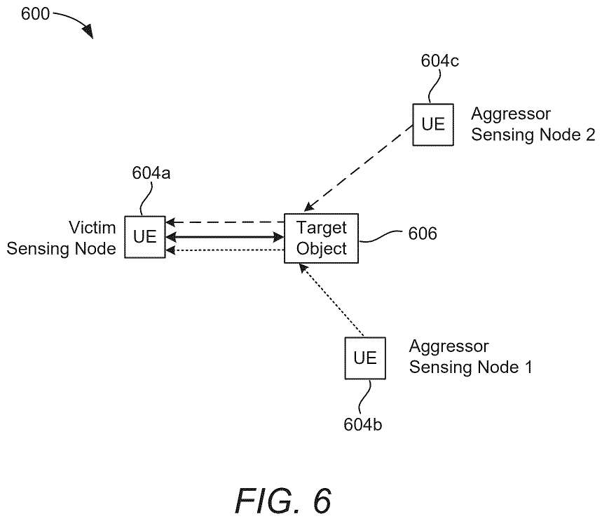

FIG. 6 illustrates an example of a sensing network 600 with multiple sensing nodes according to aspects of the disclosure. The sensing network 600 may correspond to, or include aspects of, the wireless communications system 100. Each of the first sensing node 604a, second sensing node 604b, and third sensing node 604c may correspond to, or include aspects of, the UE 104, UE 204, UE 304, or any other UE or sensing node described herein.

In the example of FIG. 6, the first sensing node 604a may be a victim sensing node. The first sensing node 604a may transmit a first FMCW sensing signal that may reflect off of target 606. The first sensing node 604a may receive the first reflection of the first FMCW sensing signal transmission and may measure the first reflection for sensing purposes. The second sensing node 604b may be a first aggressor sensing node that transmits a second FMCW sensing signal that may reflect off of the target 606. A second reflection of the second FMCW sensing signal transmission may be received by the first sensing node 604a, which may measure the second reflection for sensing purposes. The third sensing node 604c may be a second aggressor sensing node that transmits a third FMCW sensing signal that may reflect off of the target 606. A third reflection of the second FMCW sensing signal transmission may also be received by the first sensing node 604a, which may also measure the third reflection for sensing purposes.

This example scenario shows the cross-node interference that may occur when FMCW sensing signals are used by multiple sensing nodes for sensing operations. That is, for example, the first sensing node 604a may not be able to discern which of the first reflection, the second reflection, or the third reflection corresponds to the first FMCW sensing signal transmission. Thus, the second reflection and the third reflection may cause interference resulting in inaccurate sensing measurements. The cross-node interference may become exacerbated in larger networks with substantial sensing operations being performed because a limited number of parameters (e.g., a slope of the waveform) can be configured for FMCW sensing signals by each sensing node.

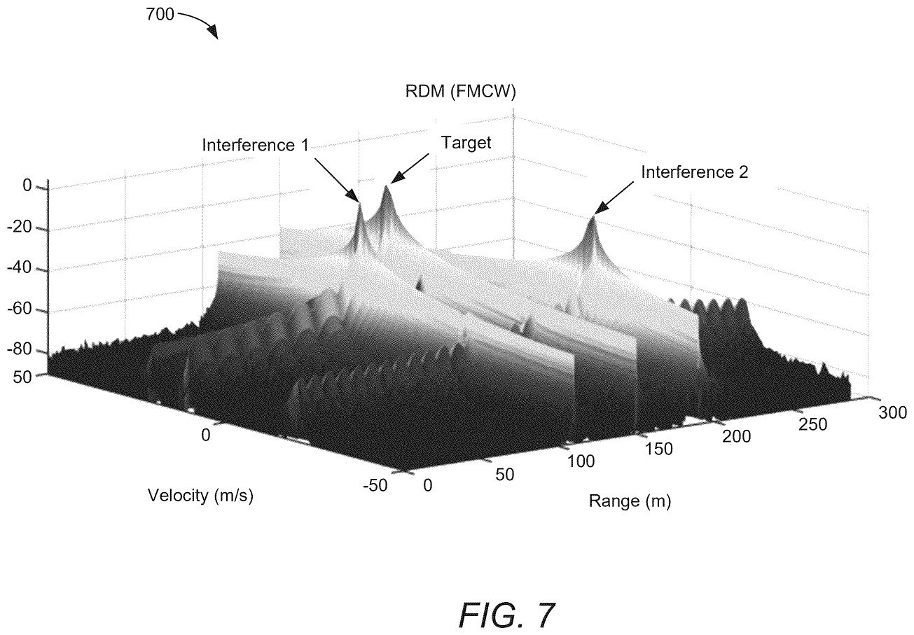

FIG. 7 illustrates an example of an interference simulation graph 700 for received sensing signals, according to aspects of the disclosure. The interference simulation graph 700 illustrates the cross-node interference in terms of a range Doppler map (RDM) of the FMCW sensing signals from the sensing network 600. The interference simulation graph 700 showing the RDM of the FMCW sensing signals is plotted using a velocity axis and a range axis.

That is, for example, each of the first sensing node 604a, second sensing node 604b, and third sensing node 604c may transmit FMCW sensing signals having one or more of the same parameters (e.g., a same slope of the waveform). Thus, the first sensing node 604a may observe the FMCW sensing signals of the other sensing nodes. That is, the interference simulation graph 700 shows the target reflection corresponding to the first reflection of the first FMCW sensing signal, as well as the first interference signal corresponding to the second reflection of the second FMCW sensing signal transmission from the first aggressor sensing node, and the second interference signal corresponding to the third reflection of the third FMCW sensing signal transmission from the second aggressor sensing node.

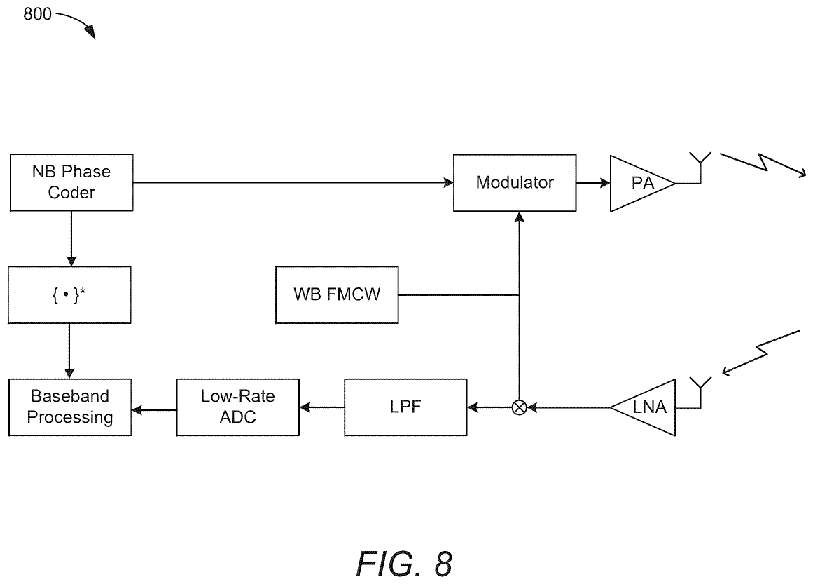

FIG. 8 illustrates an example of a circuit block diagram 800 of one or more devices that perform RF sensing, according to aspects of the disclosure. Aspects of the circuit block diagram 800 may be included in any UE, or other sensing node described herein to support hybrid continuous-wave radar techniques for secure and interference robust RF sensing. Additionally, or alternatively, one or more aspects of the circuit block diagram 800 may be separately incorporated in the various sensing nodes that transmit and/or receive FMCW sensing signals as described herein.

In some examples, a sensing node may transmit and receive scrambled sensing signal transmissions. For example, the circuit block diagram 800 may be used as a phase-coded FMCW (PC-FMCW) transceiver in a sensing node. With reference to the example of FIG. 8, a narrowband phase coder block may operate to apply a narrowband phase code in the transmitter side. That is, for example, a modulator block may receive the narrowband phase code information and modulate a wideband FMCW signal received from a wideband FMCW signal generator block with the phase code information. The resulting signal may constitute a wideband PC-FMCW signal, which the modulator block may pass to a power amplifier prior to transmitting the wideband PC-FMCW signal for use as a sensing signal via one or more antennas.

A sensing node may receive a wideband PC-FMCW signal transmission via one or more antennas. This wideband PC-FMCW signal may constitute a scrambled signal received by the circuit block diagram 800. For example, the circuit block diagram 800 may be designed to pass the receiving scrambled signal to a low noise amplifier (LNA). The LNA may pass the received scrambled signal into a mixer. The mixer may combine the received scrambled signal from the LNA with a wideband FMCW signal from the wideband FMCW signal generator block. The combined signal may be passed to a low pass filter (LPF) block, then to a low rate analog to digital converter (ADC), and then to a baseband processing block.

In some examples, the baseband processing block may receive and apply descrambling information associated with the narrowband PC information to descramble the wideband PC-FMCW signal. Accordingly, the circuit block diagram 800 may enable the sensing node to achieve at least some level of interference mitigation in accordance with some aspects.

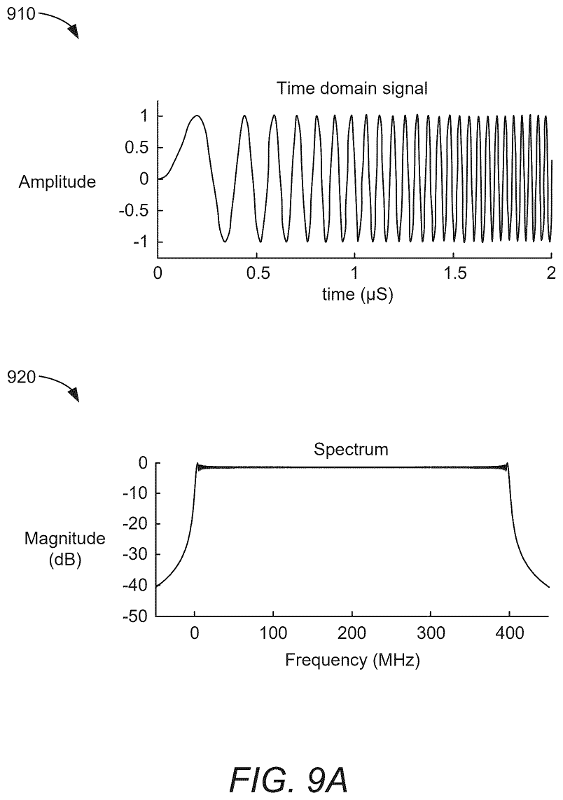

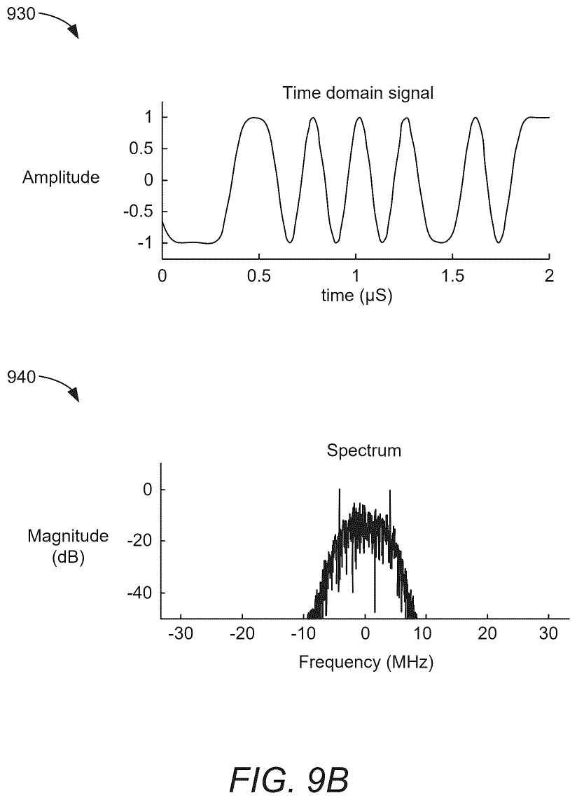

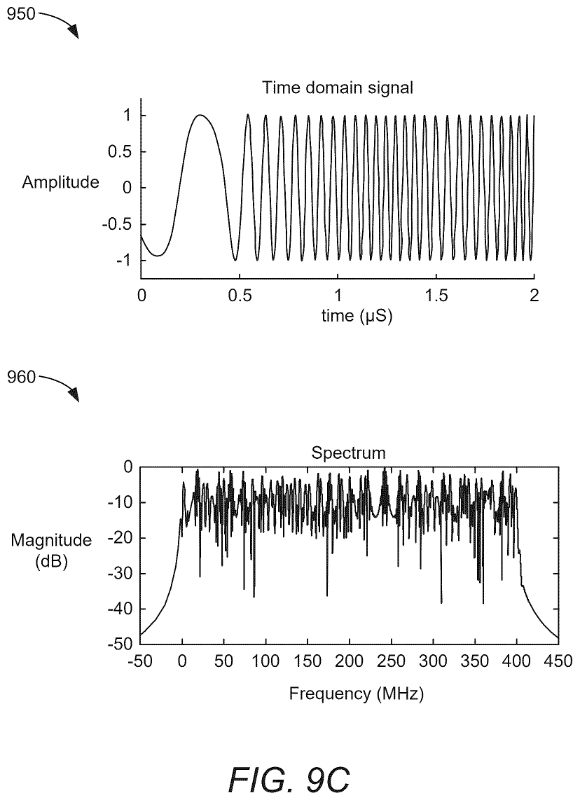

FIGS. 9A to 9C illustrate examples of time and frequency graphs for signals corresponding to the circuit block diagram 800 of FIG. 8, according to aspects of the disclosure. In the example of FIG. 9A, a first time graph 910 and first frequency graph 920 may represent the wideband FMCW signal from the wideband FMCW signal generator block. In the first time graph 910, time is represented horizontally (on the X axis) with time increasing from left to right, and amplitude is represented vertically (on the Y axis) with the amplitude of the wideband FMCW signal increasing (or decreasing) from bottom to top. In the first frequency graph 920, frequency is represented horizontally (on the X axis) with frequency increasing from left to right, and magnitude is represented vertically (on the Y axis) with the magnitude of the wideband FMCW signal increasing (or decreasing) from bottom to top.

In the example of FIG. 9B, a second time graph 930 and second frequency graph 940 may represent the narrowband PC signal from the narrowband phase coder block. In the second time graph 930, time is represented horizontally (on the X axis) with time increasing from left to right, and amplitude is represented vertically (on the Y axis) with the amplitude of the narrowband PC signal increasing (or decreasing) from bottom to top. In the second frequency graph 940, frequency is represented horizontally (on the X axis) with frequency increasing from left to right, and magnitude is represented vertically (on the Y axis) with the magnitude of the narrowband PC signal increasing (or decreasing) from bottom to top.

In the example of FIG. 9C, a third time graph 950 and third frequency graph 960 may represent the wideband PC-FMCW signal that may be transmitted by the PC-FMCW transceiver in the circuit block diagram 800. In the third time graph 950, time is represented horizontally (on the X axis) with time increasing from left to right, and amplitude is represented vertically (on the Y axis) with the amplitude of the wideband PC-FMCW signal increasing (or decreasing) from bottom to top. In the third frequency graph 960, frequency is represented horizontally (on the X axis) with frequency increasing from left to right, and magnitude is represented vertically (on the Y axis) with the magnitude of the wideband PC-FMCW signal increasing (or decreasing) from bottom to top.

It is to be noted that the wideband PC-FMCW signal may inherit certain properties of both PC signal transmissions and FMCW signal transmissions. That is, for example, the wideband PC-FMCW signal may include frequency ramping structures or noise-like characteristics in the frequency spectrum in accordance with some aspects.

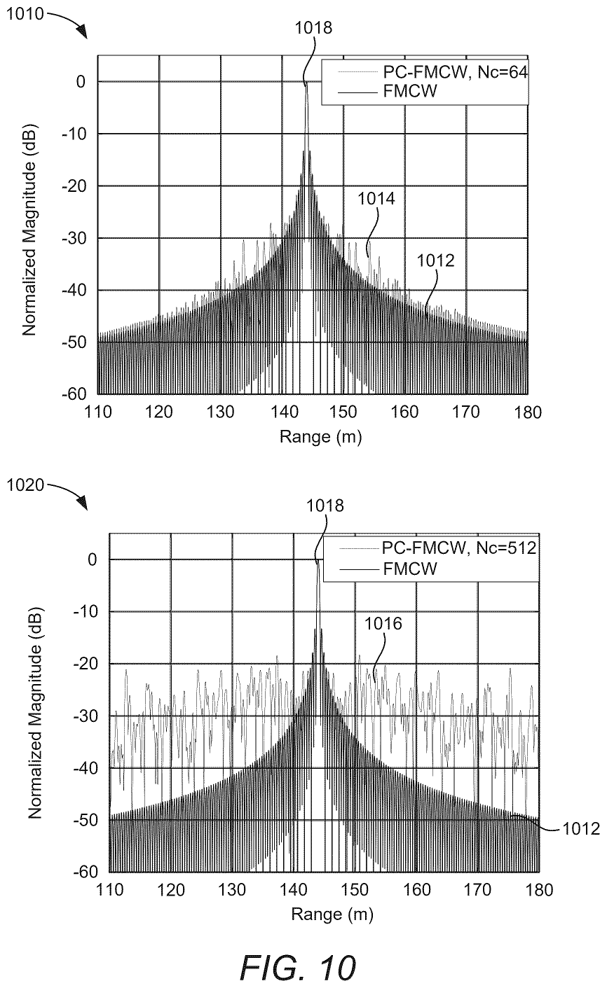

FIG. 10 illustrates examples of range estimation graphs for unscrambled and scrambled sensing signals, according to aspects of the disclosure. In some examples, the first range estimation graph 1010 and second range estimation graph 1020 may correspond to simulation results achieved from a PC-FMCW transceiver in accordance with the circuit block diagram 800 and an FMCW transceiver.

A comparison of the sensing performance between PC-FMCW signals (e.g., scrambled signals) and FMCW signals (e.g., unscrambled signals) in range estimation with different code lengths is illustrated in FIG. 10. For example, the first range estimation graph 1010 includes an FMCW signal plot 1012 and first PC-FMCW signal plot 1014. The first PC-FMCW signal plot 1014 corresponds to 64 code lengths used for the first PC-FMCW signal.

For example, the second range estimation graph 1020 includes the FMCW signal plot 1012 and a second PC-FMCW signal plot 1016. The second PC-FMCW signal plot 1016 corresponds to 512 code lengths used for the second PC-FMCW signal. It is to be noted that each signal of the FMCW signal plot 1012, first PC-FMCW signal plot 1014, the second PC-FMCW signal plot 1016 may have approximately the same peak 1018 or main lobe. In some cases, the range resolution of a PC-FMCW signal may be approximately the same as the range resolution of a FMCW signal. As can be seen in the second range estimation graph 1020 and second PC-FMCW signal plot 1016, increasing the code length per chirp may raise the side lobes (e.g., peaks other than the peak of the main lobe) of PC-FMCW signal.

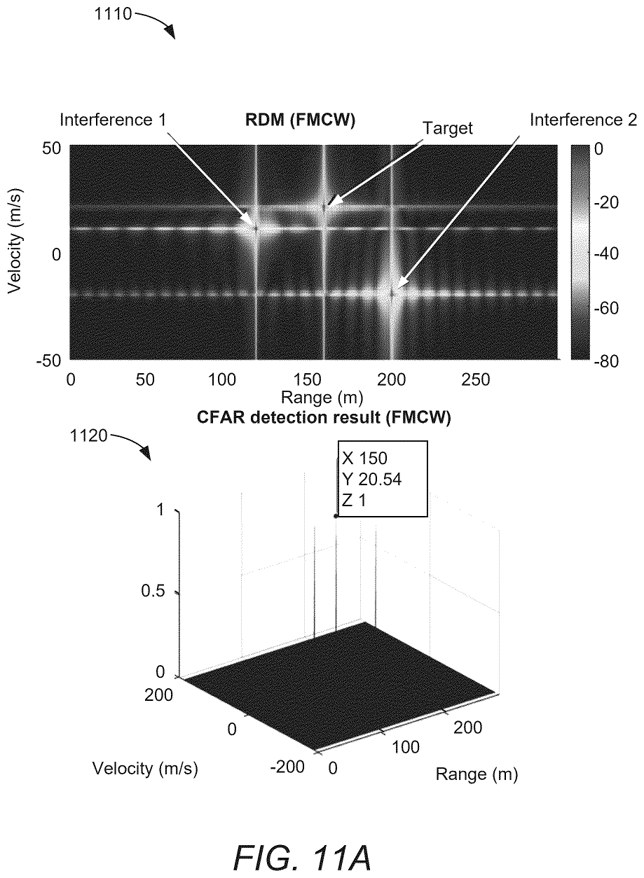

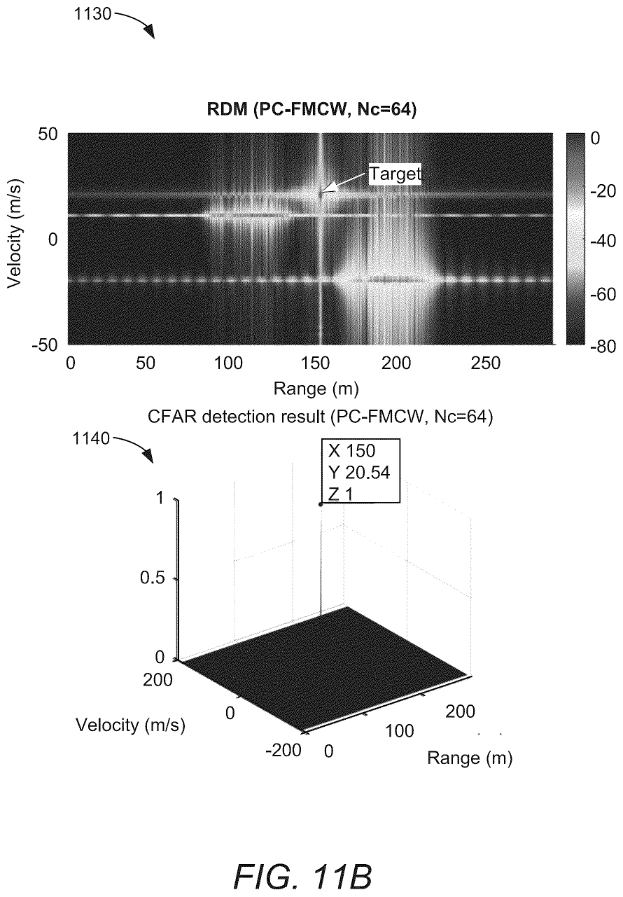

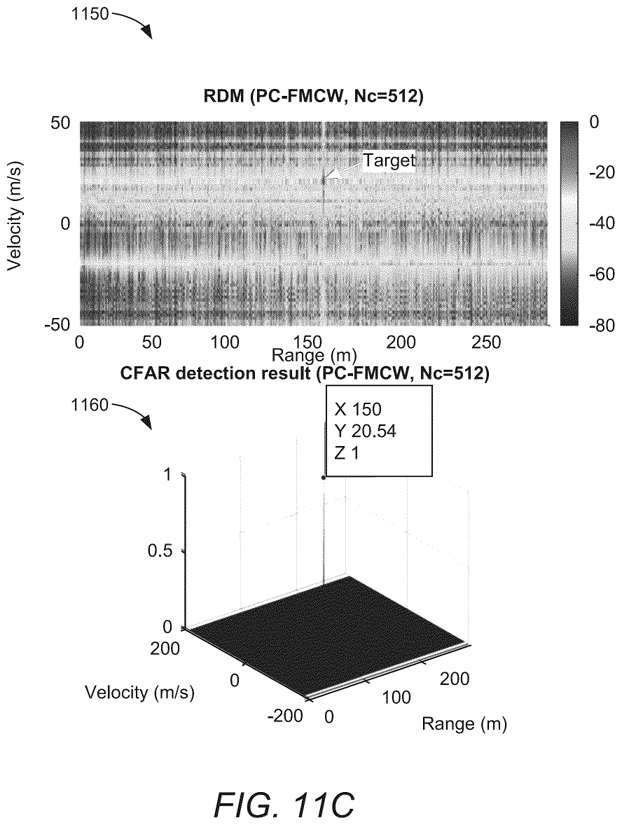

FIGS. 11A to 11C illustrate examples of range mapping diagrams and detection graphs for unscrambled and scrambled sensing signals, according to aspects of the disclosure. The examples of FIGS. 11A to 11C illustrate the trade-off between (1) sensing transmissions having unscrambled signals or scrambled signals with a low number of code lengths, which may be effective for accurate range detection, and (2) sensing transmissions having a higher number of code lengths in the scrambled signal, which may be effective for greater interference mitigation. In the examples of FIGS. 11A to 11C, the range mapping diagrams are range Doppler mapping (RDM) diagrams, and the detection graphs are constant false alarm rate (CFAR) detection graphs.

In some examples, the range mapping diagrams and detection graphs for unscrambled and scrambled sensing signals may correspond to simulation results in a sensing network, such as the sensing network 600 with multiple sensing nodes. In some examples, range mapping diagrams and detection graphs for unscrambled and scrambled sensing signals may correspond to simulation results when multiple sensing nodes use a PC-FMCW transceiver in accordance with the circuit block diagram 800 configured to transmit FMCW and PC-FMCW waveforms.

In FIG. 11A, a first RDM diagram 1110 and first CFAR detection graph 1120 are shown for a victim sensing node. In the first RDM diagram 1110, range is represented horizontally (on the X axis) with range in meters increasing from left to right, and velocity is represented vertically (on the Y axis) in meters/second. In the first CFAR detection graph 1120, range is represented on the X axis with range in meters, velocity is represented on the Y axis in meters/second, and CFAR detection results are represented on the Z axis.

The first RDM diagram 1110 and first CFAR detection graph 1120 illustrate simulation results for the victim sensing node that receives a target signal reflected from an FMCW sensing signal transmission by the victim sensing node. The victim sensing node may also receive a first interference signal corresponding to an FMCW sensing signal transmission from a first aggressor sensing node. The victim sensing node may also receive a second interference signal corresponding to an FMCW sensing signal transmission from a second aggressor sensing node. As shown in the first CFAR detection graph 1120, three peaks are detected corresponding to each of the target signal, first interference signal, and the second interference signal.

In FIG. 11B, a second RDM diagram 1130 and second CFAR detection graph 1140 are shown for the victim sensing node. In the second RDM diagram 1130, range is represented horizontally (on the X axis) with range in meters increasing from left to right, and velocity is represented vertically (on the Y axis) in meters/second. In the second CFAR detection graph 1140, range is represented on the X axis with range in meters, velocity is represented on the Y axis in meters/second, and CFAR detection results are represented on the Z axis.

The second RDM diagram 1130 and second CFAR detection graph 1140 illustrate simulation results for the victim sensing node that receives a target signal reflected from a PC-FMCW sensing signal transmission by the victim sensing node. The victim sensing node may also receive a first interference signal corresponding to a PC-FMCW sensing signal transmission from a first aggressor sensing node. The victim sensing node may also receive a second interference signal corresponding to a PC-FMCW sensing signal transmission from a second aggressor sensing node. The number of phase codes in the various PC-FMCW transmissions is 64 resulting in an increase in the side lobe levels with respect to the second and third interference signals, as shown in the second RDM diagram 1130. As shown in the second CFAR detection graph 1140, only a single peak is detected corresponding to the target signal.

In FIG. 11C, a third RDM diagram 1150 and third CFAR detection graph 1160 are shown for the victim sensing node. In the third RDM diagram 1150, range is represented horizontally (on the X axis) with range in meters increasing from left to right, and velocity is represented vertically (on the Y axis) in meters/second. In the third CFAR detection graph 1160, range is represented on the X axis with range in meters, velocity is represented on the Y axis in meters/second, and CFAR detection results are represented on the Z axis.

The third RDM diagram 1150 and third CFAR detection graph 1160 illustrate simulation results for the victim sensing node that receives a target signal reflected from a PC-FMCW sensing signal transmission by the victim sensing node. The victim sensing node may also receive a first interference signal corresponding to a PC-FMCW sensing signal transmission from a first aggressor sensing node. The victim sensing node may also receive a second interference signal corresponding to a PC-FMCW sensing signal transmission from a second aggressor sensing node. The number of phase codes in the various PC-FMCW transmissions is 512 resulting in an increase in the side lobe level with respect to the target signal, as shown in the third RDM diagram 1150. As shown in the third CFAR detection graph 1160, only a single peak is detected corresponding to the target signal.

By using scrambled signal transmissions, interference may be spread as illustrated in the second RDM diagram 1130 and third RDM diagram 1150, thereby facilitating the use of advanced algorithms for target detection as illustrated in the second CFAR detection graph 1140 and third CFAR detection graph 1160.

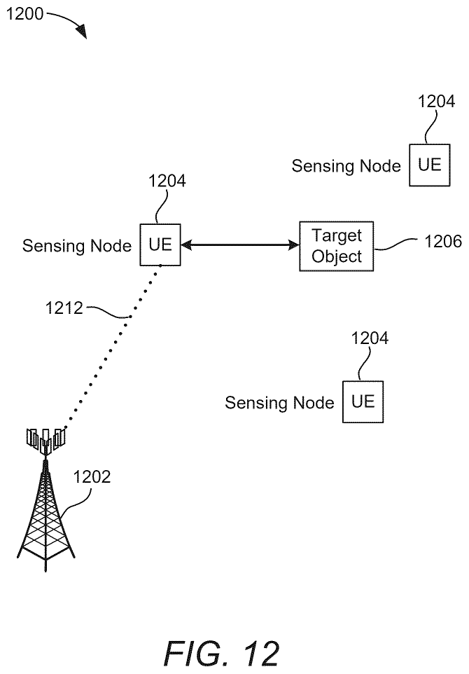

FIG. 12 illustrates an example of a sensing network 1200 with multiple sensing nodes according to aspects of the disclosure. The sensing network 1200 may correspond to, or include aspects of, the wireless communications system 100 or sensing network 600. Each sensing node 1204 may correspond to, or include aspects of, the UE 104, UE 204, UE 304, 604 or any other UE or sensing node described herein. Additionally, or alternatively, base station 1202 may be a sensing node and may correspond to, or include aspects of, the base station 102, base station 202, base station 302, or any other base station/network device or sensing node described herein.

The sensing network 1200 with multiple sensing nodes may support the various hybrid continuous-wave radar techniques described herein. That is, for example, scrambled continuous-wave radar (e.g., FMCW) waveforms may be used for cross-node interference mitigation. In some cases, the scrambling added to the continuous-wave radar waveforms may be in the time domain. That is, for example, the scrambled continuous-wave radar waveforms may be PC-FMCW waveforms. In some cases, the scrambling added to the continuous-wave radar waveforms may be in the frequency domain. That is, for example, the scrambled continuous-wave radar waveforms may be frequency domain-scrambled digital FMCW waveforms.

It is to be noted that increasing the interference mitigation may result in smaller dynamic range (e.g., peak to side lobe level), which is also a key metric for some sensing waveform designs. That is, for example, the peak to side lobe level may be critical to achieve enough dynamic range for some use cases. In some cases, a large target object radar cross-section (RCS) may cause a small target object to be missed if the small target object is close to the large target object. That is, for example, when detecting a large target object (e.g., a bus), a small target object (e.g., a person near the bus) may go undetected if the dynamic range associated with the sensing reference signal is insufficient.

Accordingly, the hybrid continuous-wave radar techniques may include reference signal designs that combine advantages of a scrambled continuous-wave waveform (e.g., PC-FMCW waveform or a frequency domain-scrambled digital FMCW waveform) and an unscrambled continuous-wave waveform (e.g., an FMCW waveform) to achieve a tradeoff between cross-node interference mitigation and sensing dynamic range.

In some examples, the sensing node 1204 may receive an indication 1212 to transmit a sensing reference signal having one or more scrambled continuous-wave waveform components. That is, for example, when the sensing node 1204 is a UE, the base station may transmit the indication 1212 to the sensing node 1204. The indication 1212 and/or signaling corresponding to the transmission of the sensing reference signal may be in the form of a reference signal configuration (e.g., via RRC) or other signaling (e.g., via DCI, MAC-CE, etc.) to the sensing node 1204. When the sensing node is the base station 1202, the indication and/or signaling may be received from another base station or a network element. In some examples, the sensing node 1204 may transmit a hybrid continuous-wave radar signal towards a target 1206 based on the indication 1212.

The indication 1212 and/or signaling may indicate various information related to the sensing operation. For example, the sensing node 1204 may receive signaling that indicates a predefined format of the hybrid continuous-wave radar signal to use for transmission. In some cases, the reference signal configuration received by the sensing node 1204 may indicate a format of the hybrid continuous-wave radar signal to use for transmission on a reference signal resource. For example, the reference signal configuration may indicate a number of scrambled continuous-wave waveform components in the format of the hybrid continuous-wave radar signal.

That is, for example, the number of scrambled continuous-wave waveform components may be based on an estimation of interference associated with the reference signal resource. For example, if there is no interference or a small amount of interference determined in the sensing channel, the ratio between unscrambled FMCW waveform components and scrambled FMCW waveform components may be high to favor the sensing dynamic range aspects. If, however, there is some amount of interference determined in the sensing channel (e.g., above an SINR threshold), the ratio between unscrambled FMCW waveform components and scrambled FMCW waveform components may be low to favor the interference mitigation aspects.

In some examples, the format of the hybrid continuous-wave radar signal may indicate at least one tuning gap between the at least one unscrambled continuous-wave waveform component and the at least one scrambled continuous-wave waveform component. That is, for example, the sending node 1204 may benefit from a time period between transmitting and/or receiving the two different waveforms to assist the transceiver tuning associated with processing the hybrid FMCW signal. For some sensing nodes and/or sensing operation scenarios or formats of the hybrid FMCW signal, a tuning gap may not be necessary, but for other sensing nodes and/or sensing operation scenarios or formats of the hybrid FMCW signal, the tuning gap may be needed.

It is to be noted that the format of the hybrid FMCW may include a bundling of the scrambled and unscrambled FMCW waveforms within a short interval (e.g., an OFDM symbol, intra-OFDM symbol, intra-FMCW waveform, etc.). Thus, in some cases, the sensing node 1204 may optimize processing gain because the sensing channel may be similar. In some cases, the sensing node 1204 may select, absent signaling, a predefined format of the hybrid continuous-wave radar signal to use for the transmission. In some case, the selection may be based on a table (or like design) know a priori to the sensing node 1204.

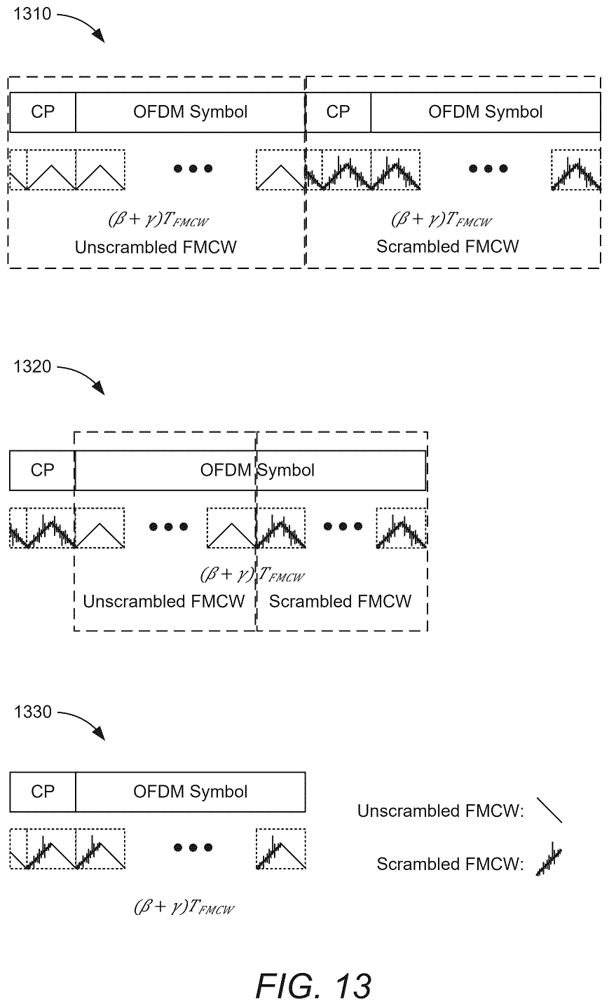

The at least one unscrambled continuous-wave waveform component and at least one scrambled continuous-wave waveform component of the hybrid continuous-wave radar signal may be arranged in various configurations and/or patterns. Some non-limiting examples of the hybrid continuous-wave radar signal are described herein with respect to FIG. 13.

FIG. 13 illustrates examples of hybrid continuous-wave waveforms, according to aspects of the disclosure. In some examples, a sensing reference signal resource may be based on or configured to include a hybrid continuous-wave waveform. These hybrid continuous-wave waveforms may be transmitted and/or received by a sensing node, such as sensing node 1204 or other sensing nodes as described herein. In some examples, these hybrid continuous-wave waveforms are compatible with a cyclic prefix (CP)-OFDM structure and numerology.

In some examples, a first hybrid FMCW format 1310 may be transmitted or received by a sensing node. The first hybrid FMCW format 1310 may be considered a symbol-level hybrid FMCW format in accordance with some aspects. For example, a first symbol may include an unscrambled FMCW waveform component and a second symbol may include a scrambled FMCW waveform component. In some cases, each sensing reference signal resource configured may include multiple symbols (e.g., a symbol configured to align with the format and numerology associated with CP-OFDM symbols). That is, for example, at least one symbol includes an unscrambled FMCW waveform component and at least one symbol includes a scrambled FMCW waveform component. In some examples, each symbol of a multiple symbol sensing reference signal transmission is: (1) a symbol that only includes one or more unscrambled waveforms, or (2) a symbol that only includes one or more scrambled waveforms, in accordance with some implementations.

In some examples, a second hybrid FMCW format 1320 may be transmitted or received by a sensing node. The second hybrid FMCW format 1320 may be considered an intra-symbol-level hybrid FMCW format in accordance with some aspects. For example, a single symbol may include an unscrambled FMCW waveform component and a scrambled FMCW waveform component. For example, each sensing reference signal symbol (e.g., a symbol configured to align with the format and numerology associated with CP-OFDM symbols) may have a first portion that includes an unscrambled FMCW waveform component and a second portion that includes a scrambled FMCW waveform component. That is, for example, each symbol configured for the sensing reference signal resource includes an unscrambled FMCW waveform component and a scrambled FMCW waveform component within that symbol.

In some examples, a third hybrid FMCW format 1330 may be transmitted or received by a sensing node. The third hybrid FMCW format 1330 may be considered an intra-FMCW waveform-level hybrid FMCW format in accordance with some aspects. For example, each sensing reference signal symbol may include one or multiple FMCW waveform components. These multiple FMCW waveform components may be arranged in various patterns (e.g., alternating or interleaving patterns) within the sensing reference signal symbol. For example, each sensing reference signal symbol (e.g., a symbol configured to align with the format and numerology associated with CP-OFDM symbols) may have multiple first portions that include unscrambled FMCW waveform components and multiple second portions that include scrambled FMCW waveform components. In some cases, each FMCW waveform within a symbol may include multiple FMCW waveform components. For example, when a triangular FMCW waveform is used, the triangular FMCW waveform may include one up-ramp chirp and one down-ramp chirp. Within each FMCW waveform, at least one FMCW waveform component of the FMCW waveform is unscrambled and at least one FMCW waveform component of the FMCW waveform is scrambled.

That is, for example, the third hybrid FMCW format 1330 may have a chirp sequence, in which a first chirp (e.g., an up-ramp chirp) of the chirp sequence correspond to an unscrambled FMCW waveform component and a second chirp (e.g., a down-ramp chirp) of the of the chirp sequence immediately following the first chirp includes a scrambled FMCW waveform component. It is to be noted that an unscrambled FMCW waveform component may be first in the time domain, and a scrambled FMCW waveform component may be second in the time domain, in accordance with some aspects. Additionally, or alternatively, the scrambled FMCW waveform component may be first in the time domain, and the unscrambled FMCW waveform component may be second in the time domain, in accordance with some aspects. It is also to be noted that other chirp sequences are contemplated as would be understood given the benefit of the disclosure.

Referring back to FIG. 12, sensing operations within the sensing network 1200 may benefit from the sensing node 1204 reporting one or more capabilities associated with support of hybrid continuous-wave waveforms. For example, in addition to whether the sensing node 1204 can support transmission or reception of hybrid continuous-wave waveforms, other capabilities that may impact the hybrid FMCW transmissions in the sensing network 1200 may be reported. For example, whether the sensing node 1204 as a receiver of the hybrid FMCW transmissions requires a tuning gap to tune the transceiver or receiver components between a scrambled FMCW waveform component and unscrambled FMCW waveform component. In some cases, the sensing node 1204 may report a minimum tuning gap value needed for the transceiver or receiver tuning procedure.

In some examples, the sensing node 1204 may receive a reference signal configuration or other indication associated with a hybrid FMCW transmission. That is, for example, the sensing node 1204 may receive an indication 1212 of certain FMCW parameters and/or the scrambling information associated with the hybrid FMCW transmission in the reference signal configuration. In some cases, a format of the hybrid FMCW waveform to be transmitted is indicated in the reference signal configuration.

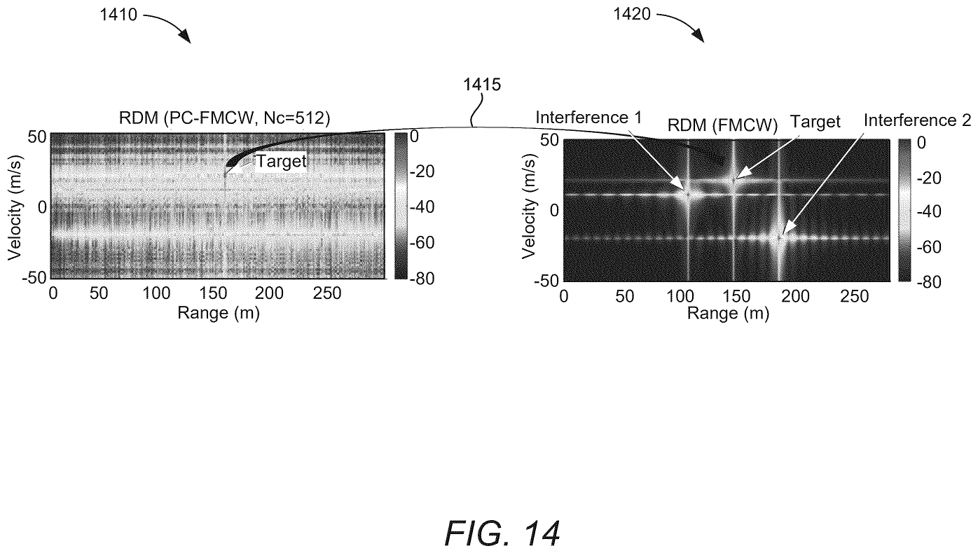

In some examples, the sensing node 1204 while receiving one or more hybrid FMCW transmissions may first determine the range-Doppler profile associated with the scrambled FMCW waveform components to detect the target 1206 and filter out any interference associated with the sensing reference signal transmissions. The sensing node 1204 may then determine the range-Doppler profile associated with the unscrambled FMCW to estimate one or more parameters corresponding to the detected target 1206. A non-limiting example of this sensing operation is described with respect to FIG. 14.

FIG. 14 illustrates examples of range mapping diagrams for unscrambled and scrambled sensing signals, according to aspects of the disclosure. The examples of FIG. 14 illustrate how unscrambled and scrambled FMCW waveform components of a hybrid continuous-wave radar reference signal may be used by a sensing node in a sensing operation. In the examples of FIG. 14, the range mapping diagrams are RDM diagrams.

In FIG. 14, a first detection-based RDM diagram 1410 is shown for a sensing node. In the first detection-based RDM diagram 1410, range is represented horizontally (on the X axis) with range in meters increasing from left to right, and velocity is represented vertically (on the Y axis) in meters/second. The scrambled signal and waveform components shown in the first detection-based RDM diagram 1410 corresponds to a PC-FMCW signal that uses 512 code lengths.

The first detection-based RDM diagram 1410 represents a first range-Doppler profile determined by the sensing node. That is, for example, the sensing node may use interference mitigation aspects of a hybrid FMCW transmission to filter out interference and detect a target signal corresponding to the target object.

A second parameter-based RDM diagram 1420 is shown in FIG. 14. That is, for example, the sensing node may perform further sensing processing 1415 upon detecting the location of the target object. In the second parameter-based RDM diagram 1420, range is represented horizontally (on the X axis) with range in meters increasing from left to right, and velocity is represented vertically (on the Y axis) in meters/second. The unscrambled signal and waveform components shown in the second parameter-based RDM diagram 1420 corresponds to an FMCW signal.

The second parameter-based RDM diagram 1420 represents a second range-Doppler profile determined by the sensing node. That is, for example, the sensing node may use sensing dynamic range aspects of the hybrid FMCW transmission to obtain more accurate parameters associated with the target signal using the second range-Doppler profile and can ignore the false positives associated with a first interference signal and second interference signal based on the results of the first range-Doppler profile illustrated in the first detection-based RDM diagram 1410.

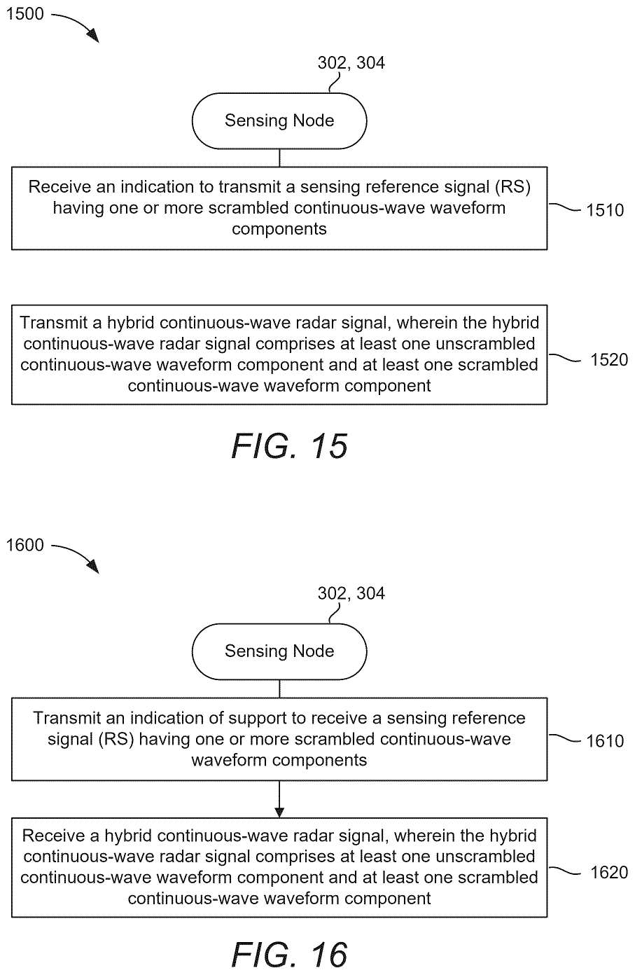

FIG. 15 is a flowchart of an example process 1500 associated with hybrid continuous-wave radar techniques, according to aspects of the disclosure. In some implementations, one or more process blocks of FIG. 15 may be performed by a sensing node (e.g., base station 302 or UE 304). In some implementations, one or more process blocks of FIG. 15 may be performed by another device or a group of devices separate from or including the sensing node. Additionally, or alternatively, one or more process blocks of FIG. 15 may be performed by one or more components of an apparatus, such as a processor(s), memory, or transceiver(s), any or all of which may be means for performing the operations of process 1500.

As shown in FIG. 15, process 1500 may include, at block 1510, receiving an indication to transmit a sensing reference signal (RS) having one or more scrambled continuous-wave waveform components. Means for performing the operation of block 1510 may include the processor(s), memory, or transceiver(s) of any of the apparatuses described herein. For example, the sensing node may receive an indication to transmit a sensing reference signal (RS) having one or more scrambled continuous-wave waveform components, using WWAN transceivers 310, 350.

As further shown in FIG. 15, process 1500 may include, at block 1520, transmitting a hybrid continuous-wave radar signal, wherein the hybrid continuous-wave radar signal comprises at least one unscrambled continuous-wave waveform component and at least one scrambled continuous-wave waveform component. Means for performing the operation of block 1520 may include the processor(s), memory, or transceiver(s) of any of the apparatuses described herein. For example, the sensing node may transmit a hybrid continuous-wave radar signal, wherein the hybrid continuous-wave radar signal comprises at least one unscrambled continuous-wave waveform component and at least one scrambled continuous-wave waveform component, using WWAN transceivers 310, 350.

Process 1500 may include additional implementations, such as any single implementation or any combination of implementations described below and/or in connection with one or more other processes described elsewhere herein.

In some aspects, process 1500 includes the at least one unscrambled continuous-wave waveform component of the hybrid continuous-wave radar signal is transmitted during a first time duration, and the at least one scrambled continuous-wave waveform component of the hybrid continuous-wave radar signal is transmitted during a second time duration different from the first time duration.

In some aspects, process 1500 includes the at least one unscrambled continuous-wave waveform component of the hybrid continuous-wave radar signal is transmitted during a first symbol in a time domain, and the at least one scrambled continuous-wave waveform component of the hybrid continuous-wave radar signal is transmitted during a second symbol in the time domain different from the first symbol.

In some aspects, each of the first symbol and the second symbol is compatible with a cyclic prefix (CP) orthogonal frequency division multiplexing (CP-OFDM) symbol.

In some aspects, process 1500 includes the at least one unscrambled continuous-wave waveform component of the hybrid continuous-wave radar signal is transmitted during a first portion of a symbol in a time domain, and the at least one scrambled continuous-wave waveform component of the hybrid continuous-wave radar signal is transmitted during a second portion of the symbol in the time domain different from the first portion.

In some aspects, process 1500 includes the hybrid continuous-wave radar signal comprises a chirp sequence, the first portion of the symbol is a first chirp of the chirp sequence, and the second portion of the symbol is a second chirp of the of the chirp sequence immediately following the first chirp.

In some aspects, process 1500 includes receiving signaling that indicates a predefined format of the hybrid continuous-wave radar signal to use for transmission, or selecting, absent signaling, the predefined format of the hybrid continuous-wave radar signal to use for the transmission.

In some aspects, process 1500 includes receiving signaling corresponding to an RS configuration that indicates a format of the hybrid continuous-wave radar signal to use for transmission on at least one RS resource.

In some aspects, the at least one scrambled continuous-wave waveform component comprises a number of scrambled continuous-wave waveform components based on an estimation of interference associated with the at least one RS resource.

In some aspects, the format of the hybrid continuous-wave radar signal indicates at least one tuning gap between the at least one unscrambled continuous-wave waveform component and the at least one scrambled continuous-wave waveform component.

In some aspects, the at least one scrambled continuous-wave waveform component comprises a phase-coded (PC) frequency-modulated continuous wave (PC-FMCW) waveform component or a frequency domain-scrambled digital FMCW waveform component, and the at least one unscrambled continuous-wave waveform component comprises an FMCW waveform component.

Although FIG. 15 shows example blocks of process 1500, in some implementations, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a flowchart of an example process 1600 associated with hybrid continuous-wave radar techniques, according to aspects of the disclosure. In some implementations, one or more process blocks of FIG. 16 may be performed by a sensing node (e.g., base station 302 or UE 304). In some implementations, one or more process blocks of FIG. 16 may be performed by another device or a group of devices separate from or including the sensing node. Additionally, or alternatively, one or more process blocks of FIG. 16 may be performed by one or more components of an apparatus, such as a processor(s), memory, or transceiver(s), any or all of which may be means for performing the operations of process 1600.

As shown in FIG. 16, process 1600 may include, at block 1610, transmitting an indication of support to receive a sensing reference signal (RS) having one or more scrambled continuous-wave waveform components. Means for performing the operation of block 1610 may include the processor(s), memory, or transceiver(s) of any of the apparatuses described herein. For example, the sensing node may transmit an indication of support to receive a sensing reference signal (RS) having one or more scrambled continuous-wave waveform components, using WWAN transceivers 310, 350.

As further shown in FIG. 16, process 1600 may include, at block 1620, receiving a hybrid continuous-wave radar signal, wherein the hybrid continuous-wave radar signal comprises at least one unscrambled continuous-wave waveform component and at least one scrambled continuous-wave waveform component. Means for performing the operation of block 1620 may include the processor(s), memory, or transceiver(s) of any of the apparatuses described herein. For example, the sensing node may receive a hybrid continuous-wave radar signal, wherein the hybrid continuous-wave radar signal comprises at least one unscrambled continuous-wave waveform component and at least one scrambled continuous-wave waveform component, using WWAN transceivers 310, 350.

Process 1600 may include additional implementations, such as any single implementation or any combination of implementations described below and/or in connection with one or more other processes described elsewhere herein.

In some aspects, process 1600 includes transmitting an indication for one or more tuning gaps between unscrambled continuous-wave waveform components and scrambled continuous-wave waveform components.

In some aspects, process 1600 includes transmitting an indication of a minimum tuning gap between an unscrambled continuous-wave waveform component and a scrambled continuous-wave waveform component.

In some aspects, process 1600 includes receiving signaling corresponding to an RS configuration that indicates one or more of a format of the hybrid continuous-wave radar signal for transmission on at least one RS resource, one or more parameters associated with the at least one unscrambled continuous-wave waveform component and at least one scrambled continuous-wave waveform component, one or more parameters associated with the at least one unscrambled continuous-wave waveform component and at least one scrambled continuous-wave waveform component, information corresponding to scrambling associated with the at least one scrambled continuous-wave waveform component, or any combination thereof.

In some aspects, process 1600 includes detecting a target based on a first range-Doppler profile using the at least one scrambled continuous-wave waveform component, and estimating one or more parameters associated with the target based on a second range-Doppler profile using the at least one unscrambled continuous-wave waveform component.

Although FIG. 16 shows example blocks of process 1600, in some implementations, process 1600 may include additional blocks, fewer blocks, different blocks, or differently arranged blocks than those depicted in FIG. 16. Additionally, or alternatively, two or more of the blocks of process 1600 may be performed in parallel.

As will be appreciated, a technical advantage of the process 1400 and 1500 may include mitigating cross-node interference while achieving sufficient dynamic range for target detection by including unscrambled and scrambled waveform components in a hybrid continuous-wave radar transmission associated with a sensing reference signal. Another technical advantage of the process 1400 and 1500 may include enabling secure sensing operation through hybrid-FMCW radar transmission by including unscrambled and scrambled FMCW waveform components in one or more symbols of a sensing reference signal. That is, for example, a signal attack from an aggressor sensing node may be filtered out through the scrambled FMCW waveform component while the performance of the sensing operation can still be maintained through the unscrambled FMCW waveform component.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a sensing node, comprising: receiving an indication to transmit a sensing reference signal (RS) having one or more scrambled continuous-wave waveform components; and transmitting a hybrid continuous-wave radar signal, wherein the hybrid continuous-wave radar signal comprises at least one unscrambled continuous-wave waveform component and at least one scrambled continuous-wave waveform component.

Clause 2. The method of clause 1, wherein: the at least one unscrambled continuous-wave waveform component of the hybrid continuous-wave radar signal is transmitted during a first time duration, and the at least one scrambled continuous-wave waveform component of the hybrid continuous-wave radar signal is transmitted during a second time duration different from the first time duration.

Clause 3. The method of any of clauses 1 to 2, wherein: the at least one unscrambled continuous-wave waveform component of the hybrid continuous-wave radar signal is transmitted during a first symbol in a time domain, and the at least one scrambled continuous-wave waveform component of the hybrid continuous-wave radar signal is transmitted during a second symbol in the time domain different from the first symbol.

Clause 4. The method of clause 3, wherein each of the first symbol and the second symbol is compatible with a cyclic prefix (CP) orthogonal frequency division multiplexing (CP-OFDM) symbol.

Clause 5. The method of any of clauses 1 to 4, wherein: the at least one unscrambled continuous-wave waveform component of the hybrid continuous-wave radar signal is transmitted during a first portion of a symbol in a time domain, and the at least one scrambled continuous-wave waveform component of the hybrid continuous-wave radar signal is transmitted during a second portion of the symbol in the time domain different from the first portion.

Clause 6. The method of clause 5, wherein: the hybrid continuous-wave radar signal comprises a chirp sequence, the first portion of the symbol is a first chirp of the chirp sequence, and the second portion of the symbol is a second chirp of the of the chirp sequence immediately following the first chirp.

Clause 7. The method of any of clauses 1 to 6, further comprising: receiving signaling that indicates a predefined format of the hybrid continuous-wave radar signal to use for transmission, or selecting, absent signaling, the predefined format of the hybrid continuous-wave radar signal to use for the transmission.

Clause 8. The method of any of clauses 1 to 7, further comprising: receiving signaling corresponding to an RS configuration that indicates a format of the hybrid continuous-wave radar signal to use for transmission on at least one RS resource.

Clause 9. The method of clause 8, wherein the at least one scrambled continuous-wave waveform component comprises a number of scrambled continuous-wave waveform components based on an estimation of interference associated with the at least one RS resource.

Clause 10. The method of any of clauses 8 to 9, wherein the format of the hybrid continuous-wave radar signal indicates at least one tuning gap between the at least one unscrambled continuous-wave waveform component and the at least one scrambled continuous-wave waveform component.

Clause 11. The method of any of clauses 1 to 10, wherein: the at least one scrambled continuous-wave waveform component comprises a phase-coded (PC) frequency-modulated continuous wave (PC-FMCW) waveform component or a frequency domain-scrambled digital FMCW waveform component, and the at least one unscrambled continuous-wave waveform component comprises an FMCW waveform component.

Clause 12. A method of wireless communication performed by a sensing node, comprising: transmitting an indication of support to receive a sensing reference signal (RS) having one or more scrambled continuous-wave waveform components; and receiving a hybrid continuous-wave radar signal, wherein the hybrid continuous-wave radar signal comprises at least one unscrambled continuous-wave waveform component and at least one scrambled continuous-wave waveform component.

Clause 13. The method of clause 12, further comprising: transmitting an indication for one or more tuning gaps between unscrambled continuous-wave waveform components and scrambled continuous-wave waveform components.

Clause 14. The method of any of clauses 12 to 13, further comprising: transmitting an indication of a minimum tuning gap between an unscrambled continuous-wave waveform component and a scrambled continuous-wave waveform component.

Clause 15. The method of any of clauses 12 to 14, further comprising: receiving signaling corresponding to an RS configuration that indicates one or more of: a format of the hybrid continuous-wave radar signal for transmission on at least one RS resource, one or more parameters associated with the at least one unscrambled continuous-wave waveform component and at least one scrambled continuous-wave waveform component, one or more parameters associated with the at least one unscrambled continuous-wave waveform component and at least one scrambled continuous-wave waveform component, information corresponding to scrambling associated with the at least one scrambled continuous-wave waveform component, or any combination thereof.

Clause 16. The method of any of clauses 12 to 15, further comprising: detecting a target based on a first range-Doppler profile using the at least one scrambled continuous-wave waveform component; and estimating one or more parameters associated with the target based on a second range-Doppler profile using the at least one unscrambled continuous-wave waveform component.

Clause 17. A sensing node, comprising: one or more memories; one or more transceivers; and one or more processors communicatively coupled to the one or more memories and the one or more transceivers, the one or more processors, either alone or in combination, configured to: receive, via the one or more transceivers, an indication to transmit a sensing reference signal (RS) having one or more scrambled continuous-wave waveform components; and transmit, via the one or more transceivers, a hybrid continuous-wave radar signal, wherein the hybrid continuous-wave radar signal comprises at least one unscrambled continuous-wave waveform component and at least one scrambled continuous-wave waveform component.

Clause 18. The sensing node of clause 17, wherein: the at least one unscrambled continuous-wave waveform component of the hybrid continuous-wave radar signal is transmitted during a first time duration, and the at least one scrambled continuous-wave waveform component of the hybrid continuous-wave radar signal is transmitted during a second time duration different from the first time duration.

Clause 19. The sensing node of any of clauses 17 to 18, wherein: the at least one unscrambled continuous-wave waveform component of the hybrid continuous-wave radar signal is transmitted during a first symbol in a time domain, and the at least one scrambled continuous-wave waveform component of the hybrid continuous-wave radar signal is transmitted during a second symbol in the time domain different from the first symbol.

Clause 20. The sensing node of clause 19, wherein each of the first symbol and the second symbol is compatible with a cyclic prefix (CP) orthogonal frequency division multiplexing (CP-OFDM) symbol.

Clause 21. The sensing node of any of clauses 17 to 20, wherein: the at least one unscrambled continuous-wave waveform component of the hybrid continuous-wave radar signal is transmitted during a first portion of a symbol in a time domain, and the at least one scrambled continuous-wave waveform component of the hybrid continuous-wave radar signal is transmitted during a second portion of the symbol in the time domain different from the first portion.

Clause 22. The sensing node of clause 21, wherein: the hybrid continuous-wave radar signal comprises a chirp sequence, the first portion of the symbol is a first chirp of the chirp sequence, and the second portion of the symbol is a second chirp of the of the chirp sequence immediately following the first chirp.

Clause 23. The sensing node of any of clauses 17 to 22, wherein the one or more processors, either alone or in combination, are further configured to: receive, via the one or more transceivers, signaling that indicates a predefined format of the hybrid continuous-wave radar signal to use for transmission, or select, absent signaling, the predefined format of the hybrid continuous-wave radar signal to use for the transmission.

Clause 24. The sensing node of any of clauses 17 to 23, wherein the one or more processors, either alone or in combination, are further configured to: receive, via the one or more transceivers, signaling corresponding to an RS configuration that indicates a format of the hybrid continuous-wave radar signal to use for transmission on at least one RS resource.

Clause 25. The sensing node of clause 24, wherein the at least one scrambled continuous-wave waveform component comprises a number of scrambled continuous-wave waveform components based on an estimation of interference associated with the at least one RS resource.

Clause 26. The sensing node of any of clauses 24 to 25, wherein the format of the hybrid continuous-wave radar signal indicates at least one tuning gap between the at least one unscrambled continuous-wave waveform component and the at least one scrambled continuous-wave waveform component.

Clause 27. The sensing node of any of clauses 17 to 26, wherein: the at least one scrambled continuous-wave waveform component comprises a phase-coded (PC) frequency-modulated continuous wave (PC-FMCW) waveform component or a frequency domain-scrambled digital FMCW waveform component, and the at least one unscrambled continuous-wave waveform component comprises an FMCW waveform component.

Clause 28. A sensing node, comprising: one or more memories; one or more transceivers; and one or more processors communicatively coupled to the one or more memories and the one or more transceivers, the one or more processors, either alone or in combination, configured to: transmit, via the one or more transceivers, an indication of support to receive a sensing reference signal (RS) having one or more scrambled continuous-wave waveform components; and receive, via the one or more transceivers, a hybrid continuous-wave radar signal, wherein the hybrid continuous-wave radar signal comprises at least one unscrambled continuous-wave waveform component and at least one scrambled continuous-wave waveform component.

Clause 29. The sensing node of clause 28, wherein the one or more processors, either alone or in combination, are further configured to: transmit, via the one or more transceivers, an indication for one or more tuning gaps between unscrambled continuous-wave waveform components and scrambled continuous-wave waveform components.

Clause 30. The sensing node of any of clauses 28 to 29, wherein the one or more processors, either alone or in combination, are further configured to: transmit, via the one or more transceivers, an indication of a minimum tuning gap between an unscrambled continuous-wave waveform component and a scrambled continuous-wave waveform component.

Clause 31. The sensing node of any of clauses 28 to 30, wherein the one or more processors, either alone or in combination, are further configured to: receive, via the one or more transceivers, signaling corresponding to an RS configuration that indicates one or more of: a format of the hybrid continuous-wave radar signal for transmission on at least one RS resource, one or more parameters associated with the at least one unscrambled continuous-wave waveform component and at least one scrambled continuous-wave waveform component, one or more parameters associated with the at least one unscrambled continuous-wave waveform component and at least one scrambled continuous-wave waveform component, information corresponding to scrambling associated with the at least one scrambled continuous-wave waveform component, or any combination thereof.

Clause 32. The sensing node of any of clauses 28 to 31, wherein the one or more processors, either alone or in combination, are further configured to: detect a target based on a first range-Doppler profile using the at least one scrambled continuous-wave waveform component; and estimate one or more parameters associated with the target based on a second range-Doppler profile using the at least one unscrambled continuous-wave waveform component.

Clause 33. A sensing node, comprising: means for receiving an indication to transmit a sensing reference signal (RS) having one or more scrambled continuous-wave waveform components; and means for transmitting a hybrid continuous-wave radar signal, wherein the hybrid continuous-wave radar signal comprises at least one unscrambled continuous-wave waveform component and at least one scrambled continuous-wave waveform component.

Clause 34. The sensing node of clause 33, wherein: the at least one unscrambled continuous-wave waveform component of the hybrid continuous-wave radar signal is transmitted during a first time duration, and the at least one scrambled continuous-wave waveform component of the hybrid continuous-wave radar signal is transmitted during a second time duration different from the first time duration.

Clause 35. The sensing node of any of clauses 33 to 34, wherein: the at least one unscrambled continuous-wave waveform component of the hybrid continuous-wave radar signal is transmitted during a first symbol in a time domain, and the at least one scrambled continuous-wave waveform component of the hybrid continuous-wave radar signal is transmitted during a second symbol in the time domain different from the first symbol.

Clause 36. The sensing node of clause 35, wherein each of the first symbol and the second symbol is compatible with a cyclic prefix (CP) orthogonal frequency division multiplexing (CP-OFDM) symbol.

Clause 37. The sensing node of any of clauses 33 to 36, wherein: the at least one unscrambled continuous-wave waveform component of the hybrid continuous-wave radar signal is transmitted during a first portion of a symbol in a time domain, and the at least one scrambled continuous-wave waveform component of the hybrid continuous-wave radar signal is transmitted during a second portion of the symbol in the time domain different from the first portion.

Clause 38. The sensing node of clause 37, wherein: the hybrid continuous-wave radar signal comprises a chirp sequence, the first portion of the symbol is a first chirp of the chirp sequence, and the second portion of the symbol is a second chirp of the of the chirp sequence immediately following the first chirp.

Clause 39. The sensing node of any of clauses 33 to 38, further comprising: means for receiving signaling that indicates a predefined format of the hybrid continuous-wave radar signal to use for transmission, or means for selecting, absent signaling, the predefined format of the hybrid continuous-wave radar signal to use for the transmission.

Clause 40. The sensing node of any of clauses 33 to 39, further comprising: means for receiving signaling corresponding to an RS configuration that indicates a format of the hybrid continuous-wave radar signal to use for transmission on at least one RS resource.

Clause 41. The sensing node of clause 40, wherein the at least one scrambled continuous-wave waveform component comprises a number of scrambled continuous-wave waveform components based on an estimation of interference associated with the at least one RS resource.

Clause 42. The sensing node of any of clauses 40 to 41, wherein the format of the hybrid continuous-wave radar signal indicates at least one tuning gap between the at least one unscrambled continuous-wave waveform component and the at least one scrambled continuous-wave waveform component.

Clause 43. The sensing node of any of clauses 33 to 42, wherein: the at least one scrambled continuous-wave waveform component comprises a phase-coded (PC) frequency-modulated continuous wave (PC-FMCW) waveform component or a frequency domain-scrambled digital FMCW waveform component, and the at least one unscrambled continuous-wave waveform component comprises an FMCW waveform component.

Clause 44. A sensing node, comprising: means for transmitting an indication of support to receive a sensing reference signal (RS) having one or more scrambled continuous-wave waveform components; and means for receiving a hybrid continuous-wave radar signal, wherein the hybrid continuous-wave radar signal comprises at least one unscrambled continuous-wave waveform component and at least one scrambled continuous-wave waveform component.

Clause 45. The sensing node of clause 44, further comprising: means for transmitting an indication for one or more tuning gaps between unscrambled continuous-wave waveform components and scrambled continuous-wave waveform components.

Clause 46. The sensing node of any of clauses 44 to 45, further comprising: means for transmitting an indication of a minimum tuning gap between an unscrambled continuous-wave waveform component and a scrambled continuous-wave waveform component.

Clause 47. The sensing node of any of clauses 44 to 46, further comprising: means for receiving signaling corresponding to an RS configuration that indicates one or more of: a format of the hybrid continuous-wave radar signal for transmission on at least one RS resource, one or more parameters associated with the at least one unscrambled continuous-wave waveform component and at least one scrambled continuous-wave waveform component, one or more parameters associated with the at least one unscrambled continuous-wave waveform component and at least one scrambled continuous-wave waveform component, information corresponding to scrambling associated with the at least one scrambled continuous-wave waveform component, or any combination thereof.

Clause 48. The sensing node of any of clauses 44 to 47, further comprising: means for detecting a target based on a first range-Doppler profile using the at least one scrambled continuous-wave waveform component; and means for estimating one or more parameters associated with the target based on a second range-Doppler profile using the at least one unscrambled continuous-wave waveform component.

Clause 49. A non-transitory computer-readable medium storing computer-executable instructions that, when executed by a sensing node, cause the sensing node to: receive an indication to transmit a sensing reference signal (RS) having one or more scrambled continuous-wave waveform components; and transmit a hybrid continuous-wave radar signal, wherein the hybrid continuous-wave radar signal comprises at least one unscrambled continuous-wave waveform component and at least one scrambled continuous-wave waveform component.

Clause 50. The non-transitory computer-readable medium of clause 49, wherein: the at least one unscrambled continuous-wave waveform component of the hybrid continuous-wave radar signal is transmitted during a first time duration, and the at least one scrambled continuous-wave waveform component of the hybrid continuous-wave radar signal is transmitted during a second time duration different from the first time duration.

Clause 51. The non-transitory computer-readable medium of any of clauses 49 to 50, wherein: the at least one unscrambled continuous-wave waveform component of the hybrid continuous-wave radar signal is transmitted during a first symbol in a time domain, and the at least one scrambled continuous-wave waveform component of the hybrid continuous-wave radar signal is transmitted during a second symbol in the time domain different from the first symbol.

Clause 52. The non-transitory computer-readable medium of clause 51, wherein each of the first symbol and the second symbol is compatible with a cyclic prefix (CP) orthogonal frequency division multiplexing (CP-OFDM) symbol.

Clause 53. The non-transitory computer-readable medium of any of clauses 49 to 52, wherein: the at least one unscrambled continuous-wave waveform component of the hybrid continuous-wave radar signal is transmitted during a first portion of a symbol in a time domain, and the at least one scrambled continuous-wave waveform component of the hybrid continuous-wave radar signal is transmitted during a second portion of the symbol in the time domain different from the first portion.

Clause 54. The non-transitory computer-readable medium of clause 53, wherein: the hybrid continuous-wave radar signal comprises a chirp sequence, the first portion of the symbol is a first chirp of the chirp sequence, and the second portion of the symbol is a second chirp of the of the chirp sequence immediately following the first chirp.

Clause 55. The non-transitory computer-readable medium of any of clauses 49 to 54, further comprising computer-executable instructions that, when executed by the sensing node, cause the sensing node to: receive signaling that indicates a predefined format of the hybrid continuous-wave radar signal to use for transmission, or select, absent signaling, the predefined format of the hybrid continuous-wave radar signal to use for the transmission.

Clause 56. The non-transitory computer-readable medium of any of clauses 49 to 55, further comprising computer-executable instructions that, when executed by the sensing node, cause the sensing node to: receive signaling corresponding to an RS configuration that indicates a format of the hybrid continuous-wave radar signal to use for transmission on at least one RS resource.

Clause 57. The non-transitory computer-readable medium of clause 56, wherein the at least one scrambled continuous-wave waveform component comprises a number of scrambled continuous-wave waveform components based on an estimation of interference associated with the at least one RS resource.

Clause 58. The non-transitory computer-readable medium of any of clauses 56 to 57, wherein the format of the hybrid continuous-wave radar signal indicates at least one tuning gap between the at least one unscrambled continuous-wave waveform component and the at least one scrambled continuous-wave waveform component.

Clause 59. The non-transitory computer-readable medium of any of clauses 49 to 58, wherein: the at least one scrambled continuous-wave waveform component comprises a phase-coded (PC) frequency-modulated continuous wave (PC-FMCW) waveform component or a frequency domain-scrambled digital FMCW waveform component, and the at least one unscrambled continuous-wave waveform component comprises an FMCW waveform component.

Clause 60. A non-transitory computer-readable medium storing computer-executable instructions that, when executed by a sensing node, cause the sensing node to: transmit an indication of support to receive a sensing reference signal (RS) having one or more scrambled continuous-wave waveform components; and receive a hybrid continuous-wave radar signal, wherein the hybrid continuous-wave radar signal comprises at least one unscrambled continuous-wave waveform component and at least one scrambled continuous-wave waveform component.

Clause 61. The non-transitory computer-readable medium of clause 60, further comprising computer-executable instructions that, when executed by the sensing node, cause the sensing node to: transmit an indication for one or more tuning gaps between unscrambled continuous-wave waveform components and scrambled continuous-wave waveform components.

Clause 62. The non-transitory computer-readable medium of any of clauses 60 to 61, further comprising computer-executable instructions that, when executed by the sensing node, cause the sensing node to: transmit an indication of a minimum tuning gap between an unscrambled continuous-wave waveform component and a scrambled continuous-wave waveform component.

Clause 63. The non-transitory computer-readable medium of any of clauses 60 to 62, further comprising computer-executable instructions that, when executed by the sensing node, cause the sensing node to: receive signaling corresponding to an RS configuration that indicates one or more of: a format of the hybrid continuous-wave radar signal for transmission on at least one RS resource, one or more parameters associated with the at least one unscrambled continuous-wave waveform component and at least one scrambled continuous-wave waveform component, one or more parameters associated with the at least one unscrambled continuous-wave waveform component and at least one scrambled continuous-wave waveform component, information corresponding to scrambling associated with the at least one scrambled continuous-wave waveform component, or any combination thereof.

Clause 64. The non-transitory computer-readable medium of any of clauses 60 to 63, further comprising computer-executable instructions that, when executed by the sensing node, cause the sensing node to: detect a target based on a first range-Doppler profile using the at least one scrambled continuous-wave waveform component; and estimate one or more parameters associated with the target based on a second range-Doppler profile using the at least one unscrambled continuous-wave waveform component.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of wireless communication performed by a sensing node, comprising:
receiving an indication to transmit a sensing reference signal (RS) having one or more scrambled continuous-wave waveform components; and
transmitting a hybrid continuous-wave radar signal, wherein the hybrid continuous-wave radar signal comprises at least one unscrambled continuous-wave waveform component and at least one scrambled continuous-wave waveform component.

2. The method of claim 1, wherein:
the at least one unscrambled continuous-wave waveform component of the hybrid continuous-wave radar signal is transmitted during a first time duration, and
the at least one scrambled continuous-wave waveform component of the hybrid continuous-wave radar signal is transmitted during a second time duration different from the first time duration.

3. The method of claim 1, wherein:
the at least one unscrambled continuous-wave waveform component of the hybrid continuous-wave radar signal is transmitted during a first symbol in a time domain, and
the at least one scrambled continuous-wave waveform component of the hybrid continuous-wave radar signal is transmitted during a second symbol in the time domain different from the first symbol.

4. The method of claim 3, wherein each of the first symbol and the second symbol is compatible with a cyclic prefix (CP) orthogonal frequency division multiplexing (CP-OFDM) symbol.

5. The method of claim 1, wherein:
the at least one unscrambled continuous-wave waveform component of the hybrid continuous-wave radar signal is transmitted during a first portion of a symbol in a time domain, and
the at least one scrambled continuous-wave waveform component of the hybrid continuous-wave radar signal is transmitted during a second portion of the symbol in the time domain different from the first portion.

6. The method of claim 5, wherein:
the hybrid continuous-wave radar signal comprises a chirp sequence,
the first portion of the symbol is a first chirp of the chirp sequence, and
the second portion of the symbol is a second chirp of the of the chirp sequence immediately following the first chirp.

7. The method of claim 1, further comprising:
receiving signaling that indicates a predefined format of the hybrid continuous-wave radar signal to use for transmission, or
selecting, absent signaling, the predefined format of the hybrid continuous-wave radar signal to use for the transmission.

8. The method of claim 1, further comprising:
receiving signaling corresponding to an RS configuration that indicates a format of the hybrid continuous-wave radar signal to use for transmission on at least one RS resource.

9. The method of claim 1, wherein:
the at least one scrambled continuous-wave waveform component comprises a phase-coded (PC) frequency-modulated continuous wave (PC-FMCW) waveform component or a frequency domain-scrambled digital FMCW waveform component, and
the at least one unscrambled continuous-wave waveform component comprises an FMCW waveform component.

10. A method of wireless communication performed by a sensing node, comprising:
transmitting an indication of support to receive a sensing reference signal (RS) having one or more scrambled continuous-wave waveform components; and
receiving a hybrid continuous-wave radar signal, wherein the hybrid continuous-wave radar signal comprises at least one unscrambled continuous-wave waveform component and at least one scrambled continuous-wave waveform component.

11. The method of claim 10, further comprising:
transmitting an indication for one or more tuning gaps between unscrambled continuous-wave waveform components and scrambled continuous-wave waveform components.

12. The method of claim 10, further comprising:
transmitting an indication of a minimum tuning gap between an unscrambled continuous-wave waveform component and a scrambled continuous-wave waveform component.

13. The method of claim 10, further comprising:
receiving signaling corresponding to an RS configuration that indicates one or more of:
a format of the hybrid continuous-wave radar signal for transmission on at least one RS resource,
one or more parameters associated with the at least one unscrambled continuous-wave waveform component and at least one scrambled continuous-wave waveform component,
one or more parameters associated with the at least one unscrambled continuous-wave waveform component and at least one scrambled continuous-wave waveform component,
information corresponding to scrambling associated with the at least one scrambled continuous-wave waveform component, or
any combination thereof.

14. The method of claim 10, further comprising:
detecting a target based on a first range-Doppler profile using the at least one scrambled continuous-wave waveform component; and
estimating one or more parameters associated with the target based on a second range-Doppler profile using the at least one unscrambled continuous-wave waveform component.

15. A sensing node, comprising:
one or more memories;
one or more transceivers; and
one or more processors communicatively coupled to the one or more memories and the one or more transceivers, the one or more processors, either alone or in combination, configured to:
receive, via the one or more transceivers, an indication to transmit a sensing reference signal (RS) having one or more scrambled continuous-wave waveform components; and
transmit, via the one or more transceivers, a hybrid continuous-wave radar signal, wherein the hybrid continuous-wave radar signal comprises at least one unscrambled continuous-wave waveform component and at least one scrambled continuous-wave waveform component.

16. The sensing node of claim 15, wherein:
the at least one unscrambled continuous-wave waveform component of the hybrid continuous-wave radar signal is transmitted during a first time duration, and
the at least one scrambled continuous-wave waveform component of the hybrid continuous-wave radar signal is transmitted during a second time duration different from the first time duration.

17. The sensing node of claim 15, wherein:
the at least one unscrambled continuous-wave waveform component of the hybrid continuous-wave radar signal is transmitted during a first symbol in a time domain, and
the at least one scrambled continuous-wave waveform component of the hybrid continuous-wave radar signal is transmitted during a second symbol in the time domain different from the first symbol.

18. The sensing node of claim 17, wherein each of the first symbol and the second symbol is compatible with a cyclic prefix (CP) orthogonal frequency division multiplexing (CP-OFDM) symbol.

19. The sensing node of claim 15, wherein:
the at least one unscrambled continuous-wave waveform component of the hybrid continuous-wave radar signal is transmitted during a first portion of a symbol in a time domain, and
the at least one scrambled continuous-wave waveform component of the hybrid continuous-wave radar signal is transmitted during a second portion of the symbol in the time domain different from the first portion.

20. The sensing node of claim 19, wherein:
the hybrid continuous-wave radar signal comprises a chirp sequence,
the first portion of the symbol is a first chirp of the chirp sequence, and
the second portion of the symbol is a second chirp of the of the chirp sequence immediately following the first chirp.

21. The sensing node of claim 15, wherein the one or more processors, either alone or in combination, are further configured to:
receive, via the one or more transceivers, signaling that indicates a predefined format of the hybrid continuous-wave radar signal to use for transmission, or
select, absent signaling, the predefined format of the hybrid continuous-wave radar signal to use for the transmission.

22. The sensing node of claim 15, wherein the one or more processors, either alone or in combination, are further configured to:
receive, via the one or more transceivers, signaling corresponding to an RS configuration that indicates a format of the hybrid continuous-wave radar signal to use for transmission on at least one RS resource.

23. The sensing node of claim 22, wherein the at least one scrambled continuous-wave waveform component comprises a number of scrambled continuous-wave waveform components based on an estimation of interference associated with the at least one RS resource.

24. The sensing node of claim 22, wherein the format of the hybrid continuous-wave radar signal indicates at least one tuning gap between the at least one unscrambled continuous-wave waveform component and the at least one scrambled continuous-wave waveform component.

25. The sensing node of claim 15, wherein:
the at least one scrambled continuous-wave waveform component comprises a phase-coded (PC) frequency-modulated continuous wave (PC-FMCW) waveform component or a frequency domain-scrambled digital FMCW waveform component, and
the at least one unscrambled continuous-wave waveform component comprises an FMCW waveform component.

26. A sensing node, comprising:
one or more memories;
one or more transceivers; and
one or more processors communicatively coupled to the one or more memories and the one or more transceivers, the one or more processors, either alone or in combination, configured to:
transmit, via the one or more transceivers, an indication of support to receive a sensing reference signal (RS) having one or more scrambled continuous-wave waveform components; and
receive, via the one or more transceivers, a hybrid continuous-wave radar signal, wherein the hybrid continuous-wave radar signal comprises at least one unscrambled continuous-wave waveform component and at least one scrambled continuous-wave waveform component.

27. The sensing node of claim 26, wherein the one or more processors, either alone or in combination, are further configured to:
transmit, via the one or more transceivers, an indication for one or more tuning gaps between unscrambled continuous-wave waveform components and scrambled continuous-wave waveform components.

28. The sensing node of claim 26, wherein the one or more processors, either alone or in combination, are further configured to:
transmit, via the one or more transceivers, an indication of a minimum tuning gap between an unscrambled continuous-wave waveform component and a scrambled continuous-wave waveform component.

29. The sensing node of claim 26, wherein the one or more processors, either alone or in combination, are further configured to:
receive, via the one or more transceivers, signaling corresponding to an RS configuration that indicates one or more of:
a format of the hybrid continuous-wave radar signal for transmission on at least one RS resource,
one or more parameters associated with the at least one unscrambled continuous-wave waveform component and at least one scrambled continuous-wave waveform component,
one or more parameters associated with the at least one unscrambled continuous-wave waveform component and at least one scrambled continuous-wave waveform component,
information corresponding to scrambling associated with the at least one scrambled continuous-wave waveform component, or
any combination thereof.

30. The sensing node of claim 26, wherein the one or more processors, either alone or in combination, are further configured to:
detect a target based on a first range-Doppler profile using the at least one scrambled continuous-wave waveform component; and
estimate one or more parameters associated with the target based on a second range-Doppler profile using the at least one unscrambled continuous-wave waveform component.
